(19) United States
(12) Patent Application Publication
(10) Pub. No.: US 2018/0252222 A1
(43) Pub. Date: Sep. 6, 2018

(54) BASE UNIT, MOTOR, AND AIR BLOWING DEVICE

(71) Applicant: Nidec Corporation, Kyoto (JP)

(72) Inventors: Yuta YAMASAKI, Kyoto (JP); Yoshihisa KITAMURA, Kyoto (JP); Tadayuki KANATANI, Kyoto (JP); Shoki YAMAZAKI, Kyoto (JP); Hideki AOI, Kyoto (JP)

(21) Appl. No.: 15/889,322

(22) Filed: Feb. 6, 2018

(30) Foreign Application Priority Data
Mar. 1, 2017 (JP) 2017-038239

(51) Int. Cl. F04D 25/08; F04D 25/06; H02K 1/12; H02K 5/16; H02K 7/14; H02K 1/27

(52) U.S. Cl. CPC F04D 25/08; F04D 25/0693; H02K 1/12; F04D 19/002; H02K 7/14; H02K 1/2786; H02K 5/16

(57) ABSTRACT

A base unit includes a tubular bearing housing that extends in an axial direction while being positioned on a central axis that extends vertically, a base plate that is connected to the bearing housing and extends in radial directions, and a stator that is provided on an upper surface of the base plate and is provided radially outward of the bearing housing. At least a portion of the base plate and at least a portion of the stator are covered by a molded portion formed of resin, the stator and the base plate are connected to each other via the molded portion, the base plate is provided with a hook portion that protrudes upwards and is caught on the molded portion at least in the axial direction, and the hook portion is disposed radially outward of the bearing housing.

### CROSS REFERENCE TO RELATED APPLICATIONS

This application claims the benefit of priority to Japanese Patent Application No. 2017-038239 filed on Mar. 1, 2017. The entire contents of this application are hereby incorporated herein by reference.

### BACKGROUND OF THE INVENTION

### 1. Field of the Invention

The present disclosure relates to a base unit, a motor, and an air blowing device.

### 2. Description of the Related Art

A fan motor in the related art is disclosed in Japanese Unexamined Patent Application Publication No. 2003-111373. The fan motor includes a stator and a rotor in a stator side case. The stator is configured by winding a winding wire around an iron core. The tubular rotor is provided with a plurality of rotor magnetic poles constituted of permanent magnets on an inner circumferential side and is provided with a plurality of blades on an outer circumferential side. The rotor magnetic poles face the stator in the radial direction. The rotor rotates around a central axis that extends in a right-left direction.

The stator side case includes a housing and a bearing supporting tubular portion. The housing extends radially outwards from the stator and surrounds outer circumferential portions of the blades of the rotor. A bearing that rotatably supports a rotation shaft of the rotor is accommodated in the bearing supporting tubular portion. The housing, the bearing supporting tubular portion, and the stator constitute a base unit. The stator is molded through injection of silicone rubber in a state of being accommodated in the stator side case. At this time, the stator, a circuit board that is connected to the winding wires and includes an electronic component, and a plurality of lead wires that are accommodated in a lead wire accommodation groove and are connected to the circuit board are molded by using silicone rubber.

However, according to the base unit disclosed in Japanese Unexamined Patent Application Publication No. 2003-111373, for example, when a gap is generated between a radially outer end of silicone rubber and a housing, the silicone rubber may peel off up to a radially inner end. Therefore, there is a problem that fixation between the housing and the stator becomes weak and the reliability of the base unit is decreased.

### SUMMARY OF THE INVENTION

An object of the disclosure is to provide a base unit, a motor, and an air blowing device with which it is possible to improve a reliability.

A base unit according to an exemplary embodiment of the disclosure includes a tubular bearing housing that extends in an axial direction while being positioned on a central axis that extends vertically, a base plate that is connected to the bearing housing and extends in radial directions, and a stator that is provided on an upper surface of the base plate and is provided radially outward of the bearing housing. At least a portion of the base plate and at least a portion of the stator are covered by a molded portion formed of resin, the stator and the base plate are connected to each other via the molded portion, the base plate is provided with a hook portion that protrudes upwards and is caught on the molded portion at least in the axial direction, and the hook portion is disposed radially outward of the bearing housing.

An exemplary motor according to the disclosure includes the base unit configured as described above, and a rotor that includes a magnet and rotates around the central axis, the magnet being disposed radially outward of the stator and the magnet facing the stator. The rotor includes a shaft that extends along the central axis and the shaft is disposed in the bearing housing via a bearing portion.

An exemplary air blowing device according to the disclosure includes the motor configured as described above, and an impeller that is provided on the rotor and rotates around the central axis by being driven by the motor. Air from one of a position above the impeller and a position below the impeller is sucked when the impeller rotates and the air is discharged to the other of the position above the impeller and the position below the impeller or the air is discharged in a circumferential direction.

According to the disclosure, it is possible to provide a base unit, a motor, and an air blowing device with which it is possible to improve a reliability.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an air blowing device in which a motor provided with a base unit according to an embodiment of the disclosure is installed.

FIG. 2 is a plan view illustrating the air blowing device in which the motor provided with the base unit according to the embodiment of the disclosure is installed.

FIG. 3 is a perspective view illustrating the inside of the air blowing device in which the motor provided with the base unit according to the embodiment of the disclosure is installed.

FIG. 4 is a side sectional view illustrating the air blowing device in which the motor provided with the base unit according to the embodiment of the disclosure is installed.

FIG. 5 is a perspective view illustrating the motor provided with the base unit according to the embodiment of the disclosure.

FIG. 6 is a perspective view of the motor provided with the base unit according to the embodiment of the disclosure, with a rotor housing and a magnet being detached.

FIG. 7 is a perspective view illustrating the base unit according to the embodiment of the disclosure.

FIG. 8 is a perspective view illustrating the base unit according to the embodiment of the disclosure before a molded portion is disposed.

FIG. 9 is a perspective view illustrating a base plate of the base unit according to the embodiment of the disclosure.

FIG. 10 is a sectional view of a hook portion of the base unit according to the embodiment of the disclosure, which is cut along a circumferential direction.

FIG. 11 is a sectional view of a conducting member holding portion of the base unit according to the embodiment of the disclosure as seen in a radial direction.

FIG. 12 is an enlarged perspective view illustrating a cable installation portion of the base unit according to the embodiment of the disclosure.

FIG. 13 is a sectional view of the cable installation portion of the base unit according to the embodiment of the disclosure, which is cut along the circumferential direction.

FIG. 14 is a sectional view of a hook portion of a base unit according to a first modification example of the embodiment of the disclosure, which is cut along the radial direction.

FIG. 15 is a sectional view of a conducting member holding portion of the base unit according to the first modification example of the embodiment of the disclosure as seen in the radial direction.

FIG. 16 is a perspective view illustrating a cable installation portion of the base unit according to the first modification example of the embodiment of the disclosure.

FIG. 17 is a sectional view of the base unit according to the first modification example of the embodiment of the disclosure, which is cut along the circumferential direction and cut with a plane passing through an insertion portion.

FIG. 18 is a sectional view of a hook portion of a base unit according to a second modification example of the embodiment of the disclosure, which is cut along the radial direction.

FIG. 19 is a perspective view illustrating a cable installation portion of the base unit according to the second modification example of the embodiment of the disclosure.

FIG. 20 is a sectional view of the base unit according to the second modification example of the embodiment of the disclosure, which is cut along the circumferential direction and cut with a plane passing through an insertion portion.

FIG. 21 is a sectional view of a hook portion of a base unit according to a third modification example of the embodiment of the disclosure, which is cut along the radial direction.

FIG. 22 is a perspective view illustrating a cable installation portion of the base unit according to the third modification example of the embodiment of the disclosure.

FIG. 23 is a sectional view of the base unit according to the third modification example of the embodiment of the disclosure, which is cut along the circumferential direction and cut with a plane passing through an insertion portion.

FIG. 24 is a perspective view illustrating a cable installation portion of a base unit according to a fourth modification example of the embodiment of the disclosure.

FIG. 25 is a sectional view of the base unit according to the fourth modification example of the embodiment of the disclosure, which is cut along the circumferential direction and cut with a plane passing through an insertion portion.

FIG. 26 is a perspective view illustrating a cable installation portion of a base unit according to a fifth modification example of the embodiment of the disclosure.

FIG. 27 is a sectional view of the base unit according to the fifth modification example of the embodiment of the disclosure, which is cut along the circumferential direction and cut with a plane passing through an insertion portion.

FIG. 28 is a perspective view illustrating a cable installation portion of a base unit according to a sixth modification example of the embodiment of the disclosure.

FIG. 29 is a sectional view of the base unit according to the sixth modification example of the embodiment of the disclosure, which is cut along the circumferential direction and cut with a plane passing through an insertion portion.

FIG. 30 is a perspective view illustrating a cable installation portion of a base unit according to a seventh modification example of the embodiment of the disclosure.

FIG. 31 is a sectional view of the base unit according to the seventh modification example of the embodiment of the disclosure, which is cut along the circumferential direction and cut with a plane passing through an insertion portion.

FIG. 32 is a sectional view of a hook portion of a base unit according to an eighth modification example of the embodiment of the disclosure, which is cut along the circumferential direction.

### DETAILED DESCRIPTION OF THE PREFERRED EMBODIMENTS

Hereinafter, an exemplary embodiment of the disclosure will be described in detail with reference to drawings. Note that, in the specification, with regard to a base unit 1, a motor 200, and an air blowing device 100, a direction parallel to a central axis C of the base unit 1 will be referred to as an “axial direction”, a direction orthogonal to the central axis C of the base unit 1 will be referred to as a “radial direction”, and a direction along an arc around the central axis C of the base unit 1 will be referred to as a “circumferential direction”.

Similarly, with regard to an impeller 102, directions that coincide with the axial direction, the radial direction, and the circumferential direction of the air blowing device 100 in a state where the impeller 102 is incorporated in the air blowing device 100 will be simply referred to as an “axial direction”, a “radial direction”, and a “circumferential direction”. In addition, in the specification, the shape of each portion and a positional relationship will be described on an assumption that the axial direction of the air blowing device 100 is the vertical direction and an intake port 103 of a fan casing 101 is above the impeller 102. In addition, the shape of each portion and the positional relationship will be described on an assumption that the axial directions of the base unit 1 and the motor 200 are the vertical direction and a base plate 2 is below a stator 3. In addition, the shape of each portion and the positional relationship will be described on an assumption that a surface of the base plate 2 on which the stator 3 is attached (a surface facing the impeller 102) is an upper surface and a surface opposite to the upper surface is a lower surface. The vertical direction is simply a term used for purpose of description and is not intended to limit the actual positional relationship or directions. In addition, expressions “upstream side” and “downstream side” respectively mean an upstream side and a downstream side in a flowing direction of air that is sucked via the intake port 103 as the impeller 102 is rotated.

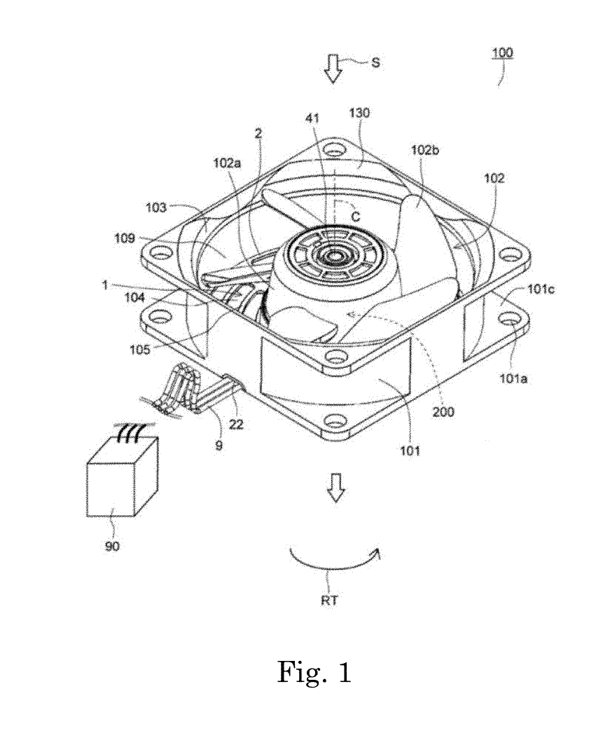

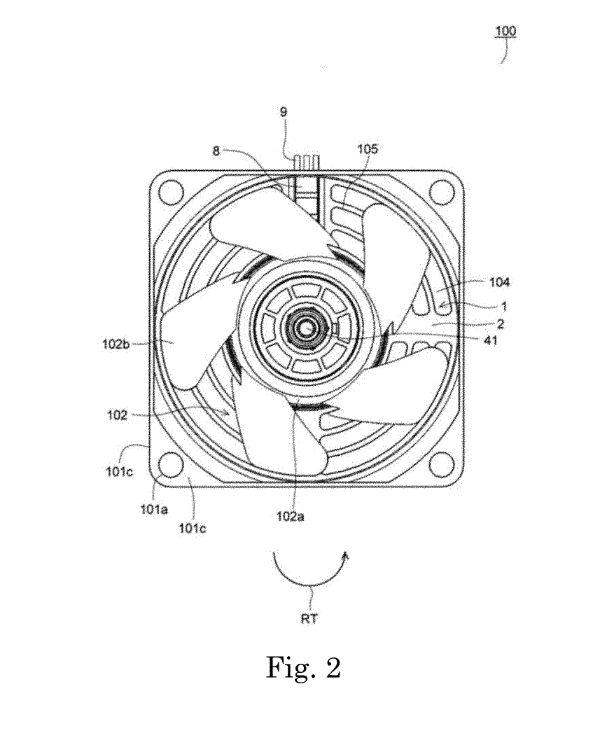

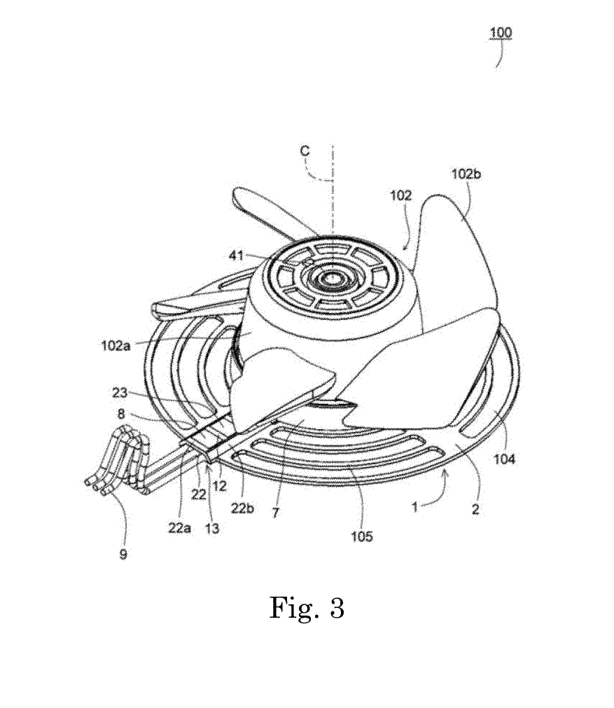

FIG. 1 is a perspective view illustrating an air blowing device in which a motor provided with a base unit according to the present embodiment is installed. FIG. 2 is a plan view illustrating the air blowing device 100. FIG. 3 is a perspective view illustrating the inside of the air blowing device 100. For example, the air blowing device 100 is installed in communication equipment (not shown) and cools an electronic component (not shown) or the like in the communication equipment. Note that, the air blowing device 100 may be installed in various types of OA equipment, medical equipment, transportation equipment, a household electrical appliance, or the like.

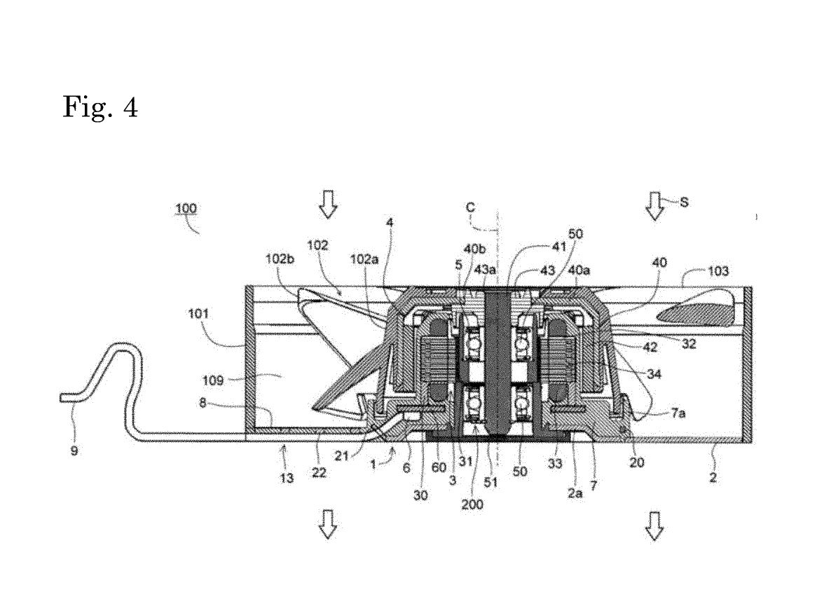

The air blowing device 100 includes the fan casing 101 which has a tubular shape in a horizontal section and the fan casing 101 accommodates the impeller 102 and the motor 200 (refer to FIG. 4). An upper end portion and a lower end portion of the fan casing 101 are provided with flange portions 101c each of which has an approximately square shape as seen in a plan view. Four corners of each of the upper and lower flange portions 101c are provided with attachment holes 101a. Screws (not shown) are inserted into the upper and lower attachment holes 101a and the screws inserted into the attachment holes 101a are screwed into screw holes (not shown) provided in an inner surface of a casing or the like of communication equipment. In this manner, the air blowing device 100 is attached to an internal portion of the communication equipment.

An upper portion of the fan casing 101 is provided with the intake port 103 which is open in the vertical direction (the axial direction). In addition, in the vicinity of the four corners of each of the flange portions 101c in the intake port 103, a bell mouth 130 is provided. The bell mouth 130 extends downwards while being curved inwards from the upper end. In addition, a lower surface of the fan casing 101 is open in the vertical direction and the base plate 2 of the base unit 1, which will be described later, is disposed on the lower surface of the fan casing 101. The base plate 2 is provided with air flowing ports 104 that penetrate the base plate 2 in the axial direction.

The impeller 102 is a so-called axial flow impeller that is formed by using a resin molded product and includes an impeller base portion 102a and a plurality of blades 102b. The impeller base portion 102a has a tubular shape that extends in the axial direction. The plurality of blades 102b are disposed on an outer circumferential surface of the impeller base portion 102a such that the blades 102b are arranged in the circumferential direction. The impeller 102 accommodates the motor 200 and when the impeller 102 is driven by the motor 200, the impeller 102 rotates in a rotation direction RT around the central axis C that vertically extends.

An air path 109 (refer to FIGS. 1 and 4) is formed in a space between an inner circumferential surface of the fan casing 101 and the impeller base portion 102a. An upper end (an upstream end) of the air path 109 communicates with the intake port 103 and a lower end (a downstream end) of the air path 109 communicates with the air flowing ports 104.

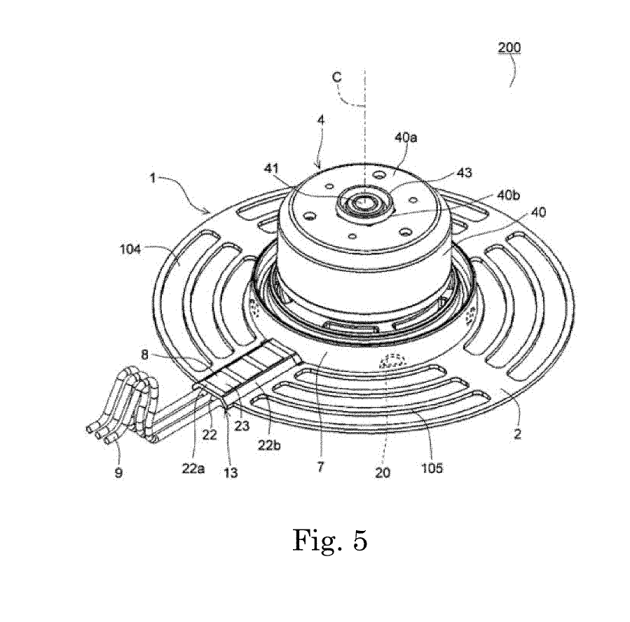

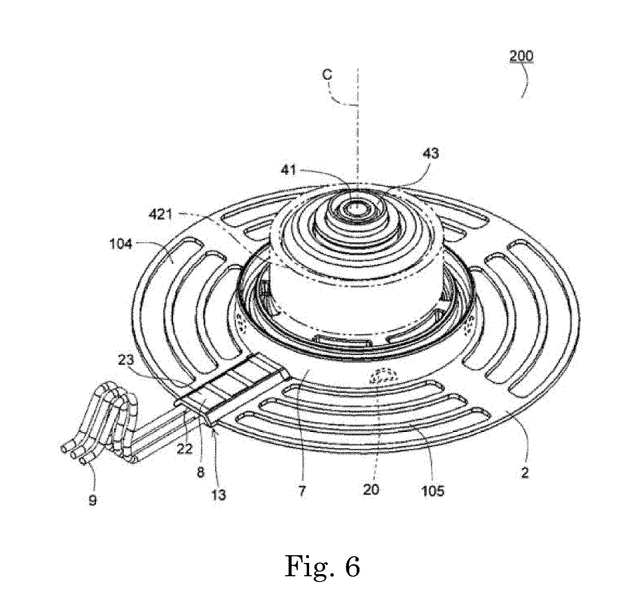

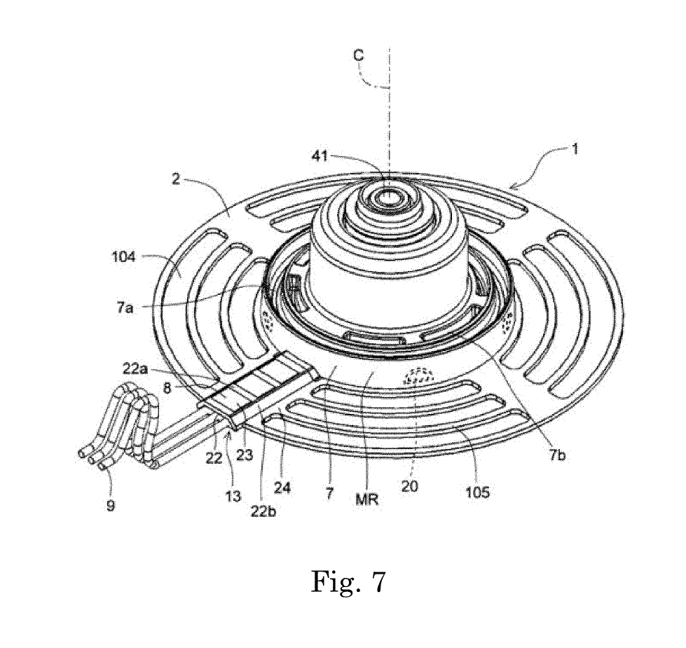

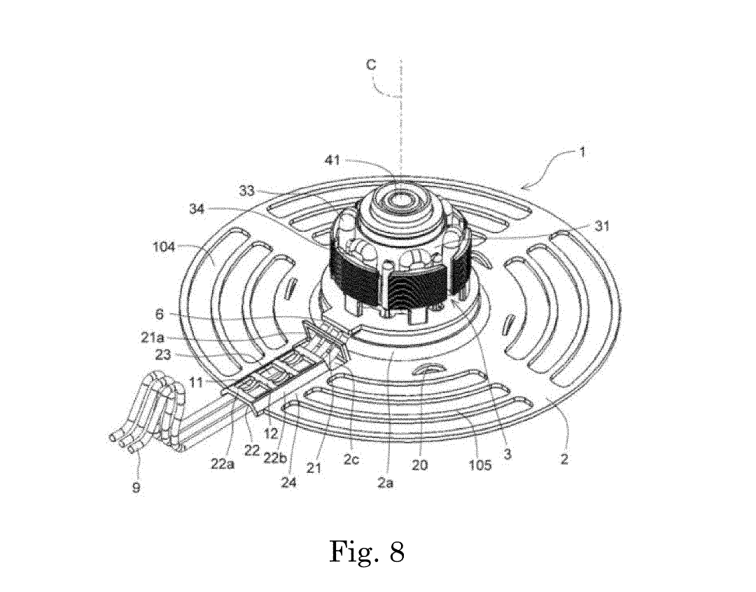

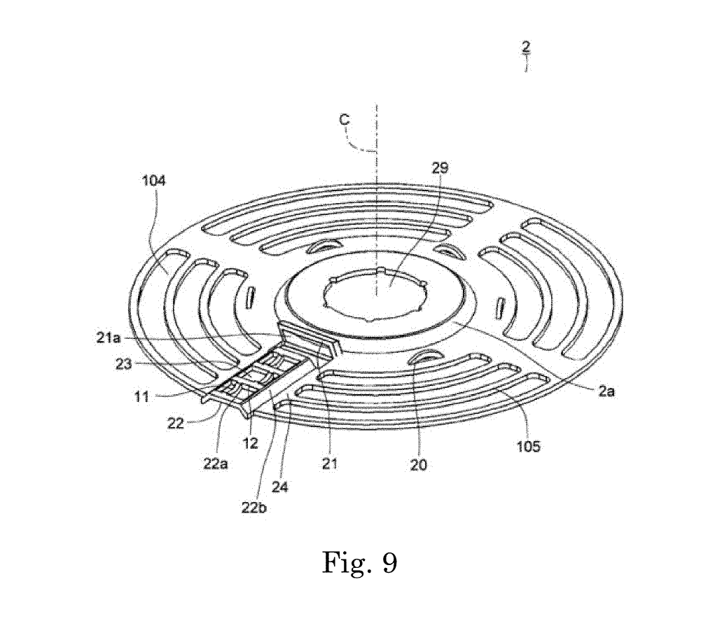

FIG. 4 is a side sectional view illustrating the air blowing device 100. FIG. 5 is a perspective view illustrating the motor 200. FIG. 6 is a perspective view of the motor 200 with a rotor housing 40 and a magnet 42 being detached. FIG. 7 is a perspective view illustrating the base unit 1. FIG. 8 is a perspective view illustrating the base unit 1 before a molded portion 7 is disposed. FIG. 9 is a perspective view illustrating the base plate 2 of the base unit 1. Note that, in FIG. 6, a two-dot chain line 421 represents a position at which the magnet 42 is disposed.

The motor 200 is a so-called outer rotor motor and is provided with the base unit 1 and a rotor 4. The base unit 1 is provided with the base plate 2, the stator 3 (refer to FIGS. 4 and 8), and a bearing housing 5 (refer to FIG. 4).

The base plate 2 is formed of, for example, metal such as aluminum and as illustrated in FIG. 9, the base plate 2 extends in the radial directions while being centered around the central axis C which extends vertically. In the present embodiment, the base plate 2 has a circular shape as seen in the axial direction (in a plan view). Note that, the base plate 2 may have a polygonal shape or an oval shape as seen in the axial direction. In addition, the base plate 2 may be formed of resin material. An outer circumferential end of the base plate 2 is positioned radially outward of the impeller base portion 102a.

The central portion of an upper surface of the base plate 2 is provided with a circular base plate protruding portion 2a that protrudes upwards. The central portion of the base plate protruding portion 2a is provided with a central through-hole 29 having an approximately circular shape that penetrates the central portion in the axial direction. The cylindrical bearing housing is inserted into the central through-hole 29 such that the bearing housing 5 is attached and the bearing housing 5 is disposed to extend upwards from the upper surface of the base plate 2. That is, the bearing housing 5 extends in the axial direction while being positioned on the central axis C which extends vertically. A lower surface of the bearing housing 5 and the central through-hole 29 are blocked by a circular cap 51 (refer to FIG. 4).

Upper and lower portions of an inner circumferential surface of the bearing housing 5 are provided with bearing portions 50(refer to FIG. 4). The upper and lower bearing portions 50 are ball bearings. Note that, the bearing portions 50 may include another type of bearing such as a slide bearing.

The stator 3 is provided on an upper surface of the base plate protruding portion 2a of the base plate 2 and is provided radially outward of the bearing housing 5. As illustrated in FIG. 4, the stator 3 includes a stator core 30 and insulators 34. The stator core 30 is constituted of stacked steel plates, which are electromagnetic steel plates stacked in the axial direction (the vertical direction), and the stator core 30 includes an annular core back 31 and a plurality of teeth 32. The core back 31 is fixed while being in contact with an outer circumferential surface of the bearing housing 5.

The plurality of teeth 32 extend radially outwards in directions from an outer circumferential surface of the core back 31 to the magnet 42 (refer to FIG. 4) of the rotor 4 and are radially disposed. Accordingly, the plurality of teeth 32 are disposed to be arranged in the circumferential direction. In the present embodiment, the number of teeth 32 provided is six. Note that, the number of teeth 32 is not limited to six and as long as the number of teeth 32 is a number greater than one.

Each of the insulators 34 is configured of insulating material such as resin and covers at least the outer circumferential surface of the core back 31 and the plurality of teeth 32.

A coil 33 obtained by winding a lead wire is provided in the vicinity of each of the teeth 32 with the insulator 34 being interposed therebetween. That is, the insulators 34 are disposed between the coils 33 and the teeth 32. Therefore, the teeth 32 and the coils 33 are insulated from each other. A lead wire (not shown) is drawn out from each coil 33.

A circuit board 60 (refer to FIGS. 4 and 8) is provided on the upper surface of the base plate protruding portion 2a and is provided below the stator 3. The circuit board 60 has a circular shape with the central portion being open and is formed of, for example, resin such as epoxy resin. A wiring pattern (not shown) is formed on the circuit board 60. A lower surface of the circuit board 60 is provided with a terminal portion 6 that is connected to the wiring pattern. The cables 9 are electrically connected to the terminal portion 6. The cables 9 constitute a conducting member. In the present embodiment, the number of cables 9 provided is three and the terminal portion 6 is provided for each cable 9.

The cables 9 are drawn radially outwards from the base plate 2 and are connected to an external power source 90 (refer to FIG. 1). Note that, instead of the cables 9, a belt-shaped flexible printed circuit board may constitute the conducting member. The lead wire of each coil 33 is electrically connected to the wiring pattern of the circuit board 60. Accordingly, the lead wire of each coil 33 is electrically connected to the cables 9 via the terminal portion 6 and the cables 9 are electrically connected to the stator 3. That is, the terminal portion 6 is provided between the stator 3 and the base plate 2 and is electrically connected to the lead wires drawn out from the coils 33. Note that, the circuit board 60 may be omitted such that the terminal portion 6 and the lead wires are directly connected to each other.

In addition, an electronic component (not shown) such as a capacitor may be mounted on the circuit board 60. In this case, the electronic component may include an AC/DC converter, an inverter, a control circuit, a position detection circuit, and the like. The control circuit controls rotation of the rotor 4 and includes an IC (not shown). The IC is not particularly limited and for example, an intelligent power module (IPM) can be used.

The central portion of the upper surface of the base plate 2, the entire circuit board 60, and the entire stator 3 are covered by the molded portion 7 (refer to FIG. 7) formed of molding resin MR (resin). In the present embodiment, the molded portion 7 has a circular shape as seen in the axial direction. Note that, the molded portion 7 may have a polygonal shape or an oval shape as seen in the axial direction. In FIG. 8, a mold (not shown) is disposed to surround a radially outer side of the stator 3 and hook portions 20, which will be described later, and the molding resin MR in a molten state is caused to flow into the mold. Thereafter, the molding resin MR in a molten state is cooled and solidified on the upper surface of the base plate 2 and the molded portion 7 is formed.

The circuit board 60, the stator 3, and the base plate 2 are connected to each other via the molded portion 7. Therefore, the stator 3 and the circuit board 60 are firmly fixed to the base plate 2. As the material of the molding resin MR, for example, hot-melt resin such as polyamide thermoplastic resin or the like can be used. Note that, the material of the molding resin MR may be another type of resin.

As illustrated in FIG. 7, an outer circumferential portion of the molded portion 7 is provided with an annular molded groove portion 7a that is recessed downwards. As illustrated in FIG. 4, a lower end portion of the impeller base portion 102a is accommodated in the molded groove portion 7a.

In addition, a portion of the molded portion 7 that is radially inward of the molded groove portion 7a and is radially outward of the stator 3 is provided with a plurality of lightening portions 7b (refer to FIG. 7). The plurality of lightening portions 7b are recessed downwards and are disposed to be arranged in the circumferential direction. Since the lightening portions 7b are provided, air bubbles inside the molded portion 7 or a void (a hollow) is prevented from being generated when the molding resin MR in a molten state is cooled and solidified.

Note that, in the present embodiment, the molded portion 7 covers the entire stator 3. However, any configuration can be adopted as long as at least a portion of the stator 3 is covered and the base plate 2 and the stator 3 are connected to each other via the molded portion 7. In addition, in the present embodiment, the molded portion 7 covers the entire circuit board 60. However, any configuration can be adopted as long as at least the terminal portion 6 is covered.

As illustrated in FIG. 9, the plurality of hook portions 20 are provided on the upper surface of the base plate 2 and are provided radially outward of the base plate protruding portion 2a. The plurality of hook portions 20 are disposed to be arranged in the circumferential direction around the central axis C. An outer circumferential end of the molded portion 7 and the hook portions are disposed radially outward of the stator 3. The hook portions 20 are embedded in the molded portion 7 and are positioned at an outer circumferential end portion of the molded portion 7. That is, the hook portions 20 are disposed radially outward of the bearing housing 5. Note that, the hook portions 20 may be disposed at positions that overlap with the stator 3 in the axial direction.

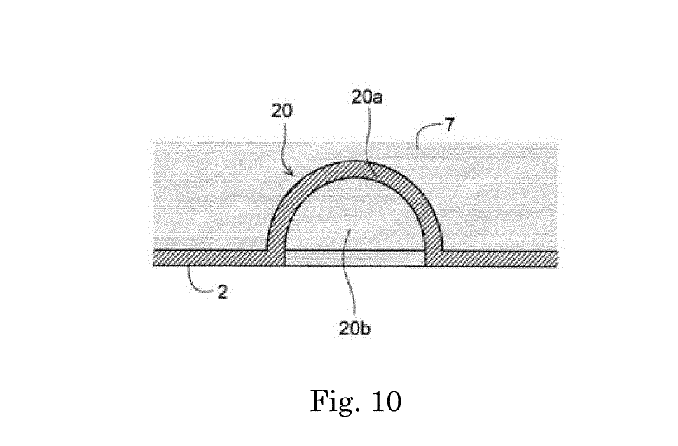

FIG. 10 is a sectional view of the hook portion 20 cut in the circumferential direction. Each hook portion 20 extends in the circumferential direction, has an approximately arc shape that protrudes upwards as seen in the radial direction, and is formed by cutting and raising the base plate 2 upwards. That is, each hook portion 20 is in a state of being cut and raised from the base plate 2. Each hook portion 20 is provided with a hook portion through-hole 20b that penetrates the hook portion 20 in the radial direction. A portion of the molded portion 7 is disposed in each hook portion through-hole 20b. Therefore, the hook portions 20 protrude upwards and are caught on the molded portion 7 at least in the axial direction.

In addition, each hook portion 20 is provided with an embedded portion 20a embedded in the molded portion 7. In the present embodiment, since the entire hook portion 20 is embedded in the molded portion 7, the entire hook portion 20 is the embedded portion 20a. The embedded portion 20a is interposed between portions of the molding resin MR in the vertical direction inside the molded portion 7. Note that, only an upper portion of the hook portion 20 may be embedded in the molded portion 7. In this case, the upper portion of the hook portion 20 is the embedded portion 20a.

In the present embodiment, the plurality of hook portions 20 are provided. However, the number of hook portions 20 may be one. For example, one hook portion 20 may have an annular shape that surrounds a radially outer side of the bearing housing 5 as seen in the axial direction. In addition, the hook portion 20 may be formed by performing welding or the like on the base plate 2 instead of cutting and rising the base plate 2. In addition, the hook portion 20 may extend in the radial direction and the hook portion through-hole 20b may penetrate the hook portion 20 in the circumferential direction.

As illustrated in FIG. 7, the base plate 2 is provided with the plurality of air flowing ports 104 that are provided radially outward of the molded portion 7. Each of the air flowing ports 104 is a long hole that penetrates the base plate 2 in the axial direction and extends in the circumferential direction. The plurality of air flowing ports 104 are arranged in the circumferential direction and the radial direction and are disposed radially while being centered around the central axis C. The area of the air flowing port 104 on the radially outer side is larger than the area of the air flowing port 104 on the radially inner side.

The base plate 2 is provided with finger guards 105 each of which is provided in a region between the air flowing ports 104 that are adjacent to each other in the radial direction. At this time, it is desirable that the width (the length in a transverse direction) of each air flowing port 104 is 12 mm or less. Accordingly, a protection level of IP2X according to an international electrotechnical commission (IEC) standard (IEC 60529) can be satisfied. Therefore, with the finger guards 105, a finger of a user is easily prevented from entering the fan casing 101.

The base plate 2 is provided with a groove portion 22 that extends radially inwards from the outer circumferential end of the base plate 2. The groove portion 22 is recessed upwards at a lower surface of the base plate 2 and is disposed between the air flowing ports 104 that are adjacent to each other in the circumferential direction. A flat portion 24 is provided in the vicinity of the groove portion 22 of the base plate 2. The groove portion 22 is provided with a bottom wall portion 22a and side wall portions 22b that connect the flat portion 24 and the bottom wall portion 22a.

A resin cover portion 8 is provided in the groove portion 22. The cover portion 8 covers at least a portion of the cables 9. Therefore, the cables 9 covered by the cover portion 8 are accommodated in the groove portion 22 and are disposed on the lower surface of the base plate 2. The material of the cover portion 8 is not limited and for example, hot-melt resin such as polyamide thermoplastic resin or the like can be used. Note that, the material of the cover portion 8 and the material of the molding resin MR of the molded portion 7 may be the same as each other and may be different from each other. The cover portion 8 is formed by causing resin in a molten state to flow from a radially outer end of the groove portion 22 to a radially inner end along the groove portion 22 after disposing the cables 9 inside the groove portion 22.

Note that, the groove portion 22 may be provided to be recessed downwards on the upper surface of the base plate 2 and the cover portion 8 may be provided in the groove portion 22. That is, the cover portion 8 may be provided on the upper surface of the base plate 2.

The bottom wall portion 22a of the groove portion 22 is provided with a plurality of insertion portions 23 that are arranged in the radial direction. In the present embodiment, the insertion portions 23 are through-holes that penetrate the bottom wall portion 22a in the axial direction. Note that, the insertion portions 23 may be notches cut in the radial direction. That is, the base plate 2 is provided with the insertion portions 23 that are through-holes penetrating the base plate 2 in a direction from the upper surface to the lower surface or notches. A portion of the cover portion 8 extends over an area from the upper surface of the base plate 2 to the lower surface of the base plate 2 while passing through the insertion portions 23. Therefore, the cover portion 8 is firmly fixed to the base plate 2. Note that, as described later, the groove portion 22 constitutes a cable installation portion 13 of the base unit 1.

As illustrated in FIGS. 8 and 9, between the base plate protruding portion 2a and the groove portion 22 of the base plate 2, a base plate through-hole 2c and a conducting member holding portion 21 are provided. The base plate through-hole 2c penetrates the base plate 2 in the axial direction and the cables 9 drawn out from the terminal portion 6 are disposed in the base plate through-hole 2c. As illustrated in FIG. 4, the conducting member holding portion 21 faces the lower end portion of the impeller base portion 102a of the impeller 102 in the axial direction. That is, the conducting member holding portion 21 faces the impeller 102 in the axial direction at the upper surface of the base plate 2. The conducting member holding portion 21 is cut and raised upwards from the base plate 2 and is erected upwards from a radially inner side of the base plate through-hole 2c. That is, the conducting member holding portion 21 is in a state of being cut and raised from the base plate 2.

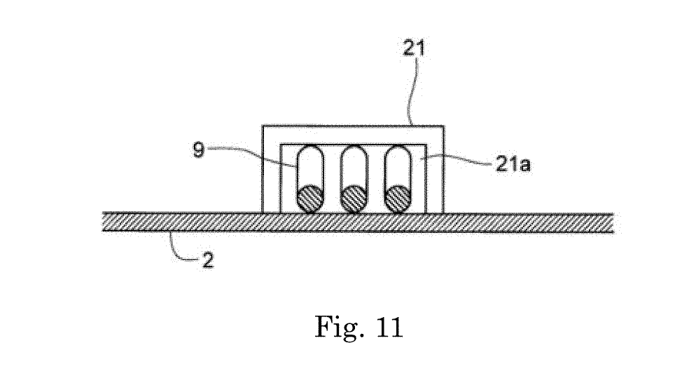

FIG. 11 is a sectional view of the conducting member holding portion 21 as seen in the radial direction. The conducting member holding portion 21 is provided with an approximately rectangular holding portion through-hole 21a that penetrates the conducting member holding portion 21 in the radial direction. Since the terminal portion 6 is disposed at a higher position than the groove portion 22, the cables 9 between the radially inner end of the groove portion 22 and the terminal portion 6 are inclined upwards as it goes toward the radially inner side. Therefore, a portion of the cables 9 is accommodated in the holding portion through-hole 21a and the cables 9 abut onto the conducting member holding portion 21 at the upper end of the holding portion through-hole 21a. Accordingly, the conducting member holding portion 21 holds the cables 9 downwards. That is, the conducting member holding portion 21 holds the cables 9 toward the base plate 2.

In the present embodiment, the entire conducting member holding portion 21 and the cables 9 are covered by the molded portion 7 and the conducting member holding portion 21 and the cables 9 are connected to each other via the molded portion 7. Note that, the conducting member holding portion 21 may not be covered by the molded portion 7 and it is preferable that at least a portion of the conducting member holding portion 21 and at least a portion of the cables 9 are covered by the molded portion 7 and the conducting member holding portion 21 and the cables 9 are connected to each other via the molded portion 7.

Note that, a plurality of conducting member holding portions 21 may be provided. In addition, the conducting member holding portion 21 may not be disposed between the groove portion 22 and the base plate protruding portion 2a. In addition, any configuration can be adopted as long as the conducting member holding portion 21 is provided on at least one of the upper and lower surfaces of the base plate 2. In a case where the conducting member holding portion 21 is provided on the lower surface of the base plate 2, the conducting member holding portion 21 holds the cables 9 upwards.

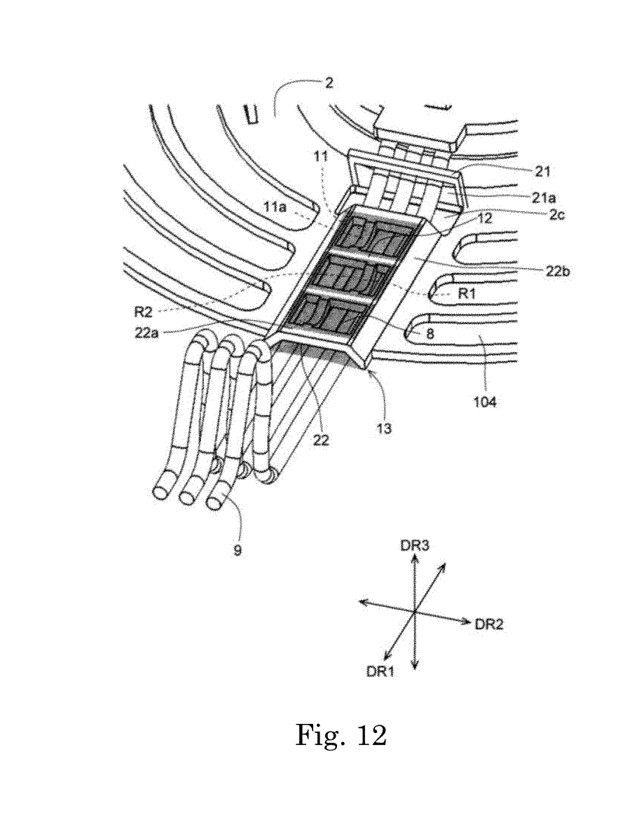

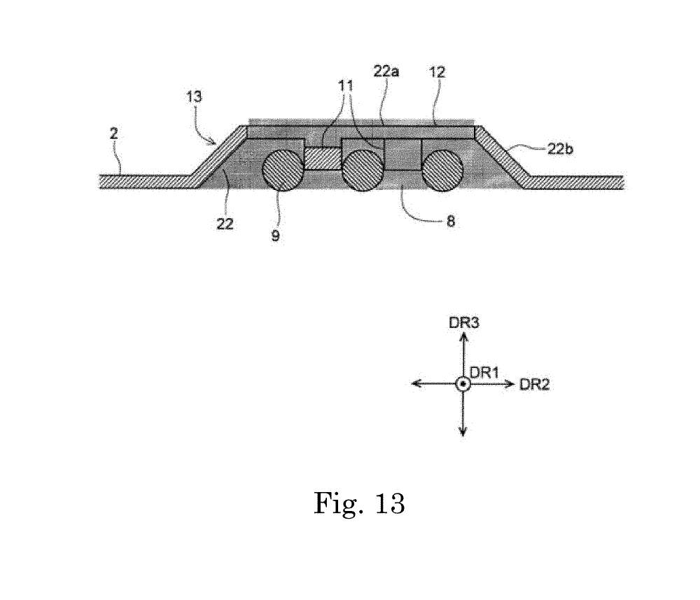

FIG. 12 is an enlarged perspective view illustrating the cable installation portion 13 of the base unit 1. FIG. 13 is a sectional view of the cable installation portion 13 which is cut along the circumferential direction. The base unit 1 includes the plurality of cables 9 that are connected to the external power source 90 (refer to FIG. 1) and extend in a predetermined first direction DR1 and the base plate 2 that is provided with the cable installation portion 13 in which the cables 9 are installed. In the present embodiment, the first direction DR1 corresponds to the radial direction. In addition, in the present embodiment, the cable installation portion 13 is provided with the groove portion 22.

The plurality of cables 9 are disposed in the cable installation portion 13 such that the cables 9 are arranged in a second direction DR2 perpendicular to the first direction DR1. The expression “perpendicular” means a case of being approximately perpendicular in addition to a case of being strictly perpendicular. Note that, the number of cables 9 is not limited to three as long as the number of cables 9 is a number greater than one. In addition, in the present embodiment, the second direction DR2 corresponds to the circumferential direction.

The cable installation portion 13 is provided with a plurality of first wall portions 11 and a plurality of second wall portions 12. Each first wall portion 11 extends in the first direction DR1 and is disposed in at least a portion of a space between the cables 9 that are adjacent to each other in the second direction DR2. Each second wall portion 12 extends in the second direction DR2 and entirely covers the plurality of cables 9 in a transverse direction. At this time, each second wall portion 12 partially covers the plurality of cables 9 in a longitudinal direction. In the present embodiment, three first wall portions 11 are provided. Note that, any configuration can be adopted as long as at least one first wall portion 11 is provided.

In the present embodiment, the first wall portions 11 are constituted of the same member as the base plate 2. For example, the first wall portions 11 are formed of metal such as aluminum as with the base plate 2. Note that, the first wall portions 11 may be constituted of a member different from that of the base plate 2. The plurality of first wall portions 11 are disposed at intervals in the first direction DR1. In addition, the cables 9 and the first wall portions 11 are fixed to each other via molding resin such as polyamide thermoplastic resin. For example, the cables 9 and the first wall portions 11 are fixed to each other via the molding resin by causing molding resin in a molten state to flow from the radially outer end of the groove portion 22 to the radially inner end in the radial direction (the first direction DR1) after disposing the cables 9 inside the groove portion 22.

A disposition region R1 in which the first wall portion 11 is disposed is provided in one space between the cables 9. A non-disposition region R2 in which the first wall portion 11 is not disposed is provided in the other space between the cables 9. The disposition region R1 and the non-disposition region R2 overlap each other in the second direction DR2. In addition, two first wall portions 11 that are adjacent to one cable 9 and are provided on the opposite sides with respect to the cable 9 are disposed at different positions in the first direction DR1. That is, the two first wall portions 11 that are provided on the opposite sides with respect to the cable 9 do not overlap each other in the second direction DR2. Therefore, the plurality of first wall portions 11 are disposed in a zigzag shape as seen in the axial direction.

Each first wall portion 11 is provided with a recess portion 11a that is recessed toward the cable 9 side in a third direction DR3 that is perpendicular to the first direction DR1 and the second direction DR2. Each recess portion 11a is filled with a portion of molding resin. In the present embodiment, the third direction DR3 corresponds to the axial direction. Note that, each recess portion 11a may be recessed toward a side opposite to the cable 9 side in the third direction DR3 and each recess portion 11a may be filled with a portion of molding resin.

The plurality of second wall portions 12 are disposed to be arranged in the first direction DR1. In the present embodiment, the number of second wall portions 12 provided is four. The opposite end portions of the first wall portion 11 in the first direction DR1 are connected to the second wall portion 12. Note that, any configuration can be adopted as long as one end portion of the first wall portion 11 in the first direction DR1 is connected to the second wall portion 12.

The rotor 4 includes the cylindrical rotor housing 40 (refer to FIGS. 4 and 5), which is provided with a lid portion 40a on the upper surface thereof, and the single annular magnet 42 (refer to FIGS. 4 and 6). The magnet 42 is disposed on an inner circumferential surface of the rotor housing 40. A radially inner surface of the magnet 42 faces a radially outer end surface of each of the teeth 32. That is, the magnet 42 is disposed radially outward of the stator 3 and faces the stator 3 in the radial direction. The radially inner surface of the magnet 42 is magnetized by the N pole and the S pole in the circumferential direction, alternately.

Note that, instead of the single annular magnet 42, a plurality of magnets may be used. In this case, any configuration can be adopted as long as N-pole surfaces and S-pole surfaces of the plurality of magnets are alternately arranged at regular intervals in the circumferential direction. In addition, a magnet and a rotor housing may be integrally molded by using resin mixed with magnetic powders.

As illustrated in FIG. 4, the central portion of the lid portion 40a of the rotor housing 40 is provided with a rotor hole portion 40b that penetrates the lid portion 40a in the axial direction. A bush 43 is inserted into the rotor hole portion 40b and is fixed to the lid portion 40a. The central portion of the bush 43 is provided with a boss hole 43a that penetrates the bush 43 in the axial direction. An upper portion of a columnar shaft 41 that extends in the axial direction is fixed to the boss hole 43a. Accordingly, the rotor housing 40 holds the shaft 41 that extends in the axial direction while being positioned on the central axis C.

The shaft 41 is supported by the upper and lower bearing portions 50 in the bearing housing 5 and rotates in the rotation direction RT (refer to FIGS. 1 and 2) around the central axis C together with the rotor housing 40. That is, the rotor 4 includes the shaft 41 that extends along the central axis C and the shaft 41 is disposed in the bearing housing 5 via the bearing portions 50. The impeller base portion 102a of the impeller 102 is attached to an outer circumferential surface of the rotor housing 40. Accordingly, the impeller 102 is connected to the motor 200 and the impeller 102 rotates around the central axis C as the rotor 4 rotates.

As described above, the base unit 1 is provided with the tubular bearing housing 5 that extends in the axial direction while being positioned on the central axis C that extends vertically, the base plate 2 that is connected to the bearing housing 5 and extends in the radial directions, and the stator 3 that is provided on the upper surface of the base plate 2 and is provided radially outward of the bearing housing 5. At least a portion of the base plate 2 and at least a portion of the stator 3 are covered by the molded portion 7 formed of the molding resin MR (resin). The stator 3 and the base plate 2 are connected to each other via the molded portion 7. The base plate 2 is provided with the hook portions 20 that protrude upwards and are caught on the molded portion 7 at least in the axial direction. The hook portions 20 are disposed radially outward of the bearing housing 5. Therefore, the hook portions 20 can easily resist a force applied to the molded portion 7 in the axial direction and thus it is possible to prevent the molded portion 7 from peeling off the base plate 2.

In addition, the base unit 1 is provided with the tubular bearing housing 5 that extends in the axial direction while being positioned on the central axis C that extends vertically, the base plate 2 that is connected to the bearing housing 5 and extends in the radial directions, the stator 3 that is provided on the upper surface of the base plate 2 and is provided radially outward of the bearing housing 5, and the cables 9 (the conducting member) that are electrically connected to the stator 3 and are drawn out radially outwards from the base plate 2. The conducting member holding portion 21 that holds at least a portion of the cables 9 toward the base plate 2 is provided on at least one of the upper and lower surfaces of the base plate 2. The conducting member holding portion 21 is in a state of being cut and raised from the base plate 2. Therefore, it is possible to prevent the cables 9 from rising and being separated (lifted) from the base plate 2, from a predetermined position at which the cables 9 are held.

Note that, in the present embodiment, the cover portion 8 of the base unit 1 may be omitted. In addition, the molded portion 7 may not cover the conducting member holding portion 21. Even this case, with the conducting member holding portion 21, it is possible to prevent the cables 9 from being lifted from the base plate 2.

In addition, the base unit 1 is provided with the tubular bearing housing 5 that extends in the axial direction while being positioned on the central axis C that extends vertically, the base plate 2 that is connected to the bearing housing 5 and extends in the radial directions, the stator 3 that is provided on the upper surface of the base plate 2 and is provided radially outward of the bearing housing 5, and the cables 9 (the conducting member) that are electrically connected to the stator 3 and are drawn out radially outwards from the base plate 2. The upper surface or the lower surface of the base plate 2 is provided with the resin cover portion 8 that covers at least a portion of the cables 9. The base plate 2 is provided with the insertion portions 23 that are through-holes penetrating the base plate 2 in a direction from the upper surface to the lower surface or notches. A portion of the cover portion 8 extends over an area from the upper surface of the base plate 2 to the lower surface of the base plate 2 while passing through the insertion portions 23. Accordingly, it is possible to prevent the cover portion 8 from peeling off the base plate 2. In addition, it is possible to prevent the cables 9 from being lifted on the base plate 2.

In addition, the base unit 1 connected to the external power source 90 includes the plurality of cables 9 that are electrically connected to the external power source 90 and extend in the predetermined first direction DR1 and the base plate 2 that is provided with the cable installation portion 13 in which the cables 9 are installed. The plurality of cables 9 are disposed to be arranged in the second direction DR2 perpendicular to the first direction DR1. The cable installation portion 13 is provided with at least one first wall portion 11 that extends in the first direction DR1. Each first wall portion 11 is disposed in at least a portion of a space between the cables 9 that are adjacent to each other. The cables 9 and the first wall portions 11 are fixed to each other via the molding resin. Therefore, it is possible to firmly fix the cables 9 to the cable installation portion 13.

In the air blowing device 100 configured as described above, when power is supplied to the coils 33 via the cables 9 from the external power source 90, a magnetic flux is generated around the stator core 30. In addition, a torque in the circumferential direction is generated due to a magnetic flux between the stator core 30 and the magnet 42. Therefore, the rotor 4 rotates relative to the stator 3 in the rotation direction RT (refer to FIGS. 1 and 2) around the central axis C.

When the rotor 4 rotates, the impeller 102 rotates in the rotation direction RT and air from a position above the impeller 102 is sucked. The air sucked from the position above the impeller 102 flows into the air path 109, passes through a space between the adjacent blades 102b, and is accelerated downwards by the rotating impeller 102. The air accelerated downwards is discharged to a position below the impeller 102.

That is, the air blowing device 100 is provided with the motor 200 and the impeller 102 that is provided on the rotor 4 and rotates around the central axis C by being driven by the motor 200. In addition, air from a position above the impeller 102 is sucked when the impeller 102 rotates and the air is discharged downwards. Therefore, as illustrated by an arrow S (refer to FIGS. 1 and 4), an air stream that flows from the upper side to the lower side is generated.

At this time, air sucked via the intake port 103 is rectified by the bell mouth 130 and is guided to a space between the adjacent blades 102b. Therefore, it is possible to improve the air suctioning efficiency of the air blowing device 100.

The air stream proceeding to a position below the impeller 102 is discharged to the outside of the fan casing 101 via the air flowing port 104. The air stream discharged to the outside of the fan casing 101 is discharged to the outside of the communication equipment after colliding with the electronic component or the like in the communication equipment. In this manner, the air blowing device 100 can cool the electronic component or the like in the communication equipment.

Note that, the motor 200 may be inverted such that the impeller 102 rotates in a direction opposite to the rotation direction RT. In this case, air is sucked via the air flowing port 104 and the air is discharged via the intake port 103.

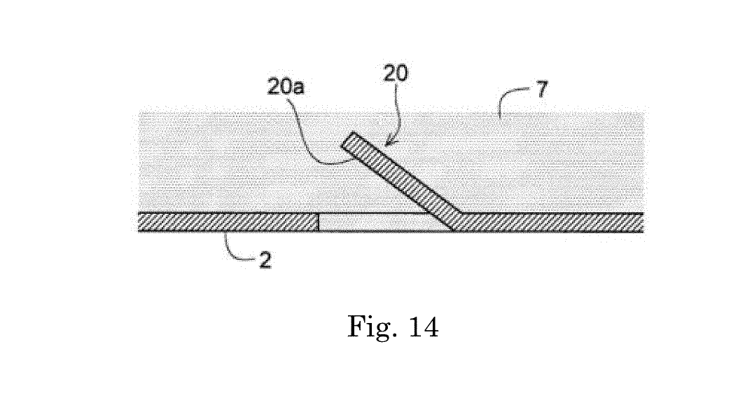

FIG. 14 is a sectional view of the hook portion 20 of the base unit 1 according to a first modification example of the present embodiment, which is cut along the radial direction. Each hook portion 20 has a plate shape cut and raised upwards from the base plate 2 and is the same member as the base plate 2. Each hook portion 20 may be inclined with respect to the base plate 2. Accordingly, it is possible to easily realize the hook portions 20.

Note that, only upper portions of the hook portions 20 may be embedded in the molded portion 7. In this case, only upper portions of the hook portions 20 are the embedded portions 20a. Since the hook portions 20 are embedded in the molded portion 7, it is possible to prevent the molded portion 7 from falling off in the axial direction. In addition, since the molded portion 7 covers a surface of each hook portion 20 in the circumferential direction or the radial direction with the hook portions 20 embedded in the molded portion 7, it is possible to suppress movement of the molded portion 7 in the circumferential direction or the radial direction.

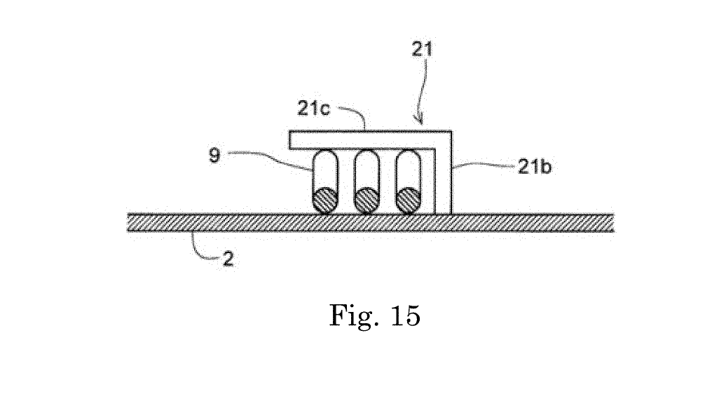

FIG. 15 is a sectional view of the conducting member holding portion 21 of the base unit 1 according to the first modification example of the present embodiment as seen in the radial direction. The conducting member holding portion 21 may be provided with a protruding portion 21b that protrudes upwards from the base plate 2 and a curved portion 21c that is curved from an upper end (tip end) of the protruding portion 21b in the circumferential direction. At this time, at least a portion of the cables 9 is accommodated between the curved portion 21c and the base plate 2 and abuts onto a lower end of the curved portion 21c. Therefore, it is possible to easily realize the conducting member holding portion 21 and to easily restrict movement of the cables 9 in the vertical direction (the axial direction). In addition, since a portion that is open in the circumferential direction is provided between the base plate 2 and the curved portion 21c, it is possible to easily insert the cables 9 into the conducting member holding portion 21 via the portion open in the circumferential direction.

Note that, the protruding portion 21b may protrude downwards and at least a portion of the cables 9 may be accommodated between the curved portion 21c and the base plate 2. In addition, a direction in which the curved portion 21c is curved is not limited to the circumferential direction as long as the direction is a direction perpendicular to the axial direction.

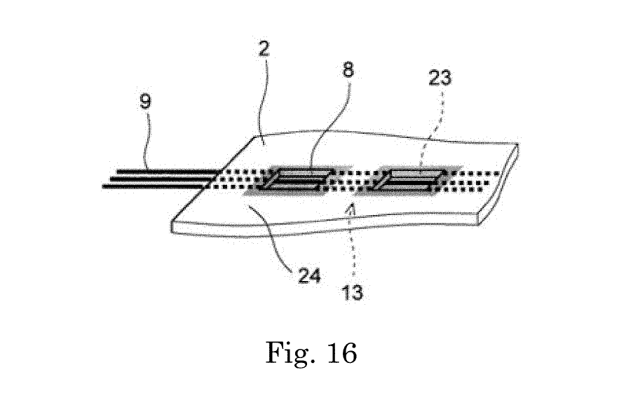

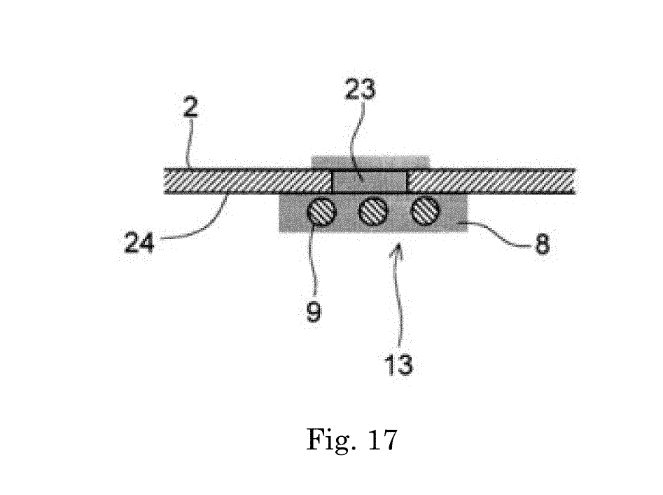

FIG. 16 is a perspective view illustrating the cable installation portion 13 of the base unit 1 according to the first modification example of the present embodiment. FIG. 17 is a sectional view of the base unit 1 according to the first modification example which is cut along the circumferential direction and cut with a plane passing through the insertion portion 23. Note that, in FIGS. 16 and 17, FIGS. 19 and 20, and FIGS. 22 to 31 which will be described later, the first wall portions 11 are omitted. In the present modification example, the groove portion 22 of the base plate 2 is omitted. The base plate 2 may be provided with the flat portion 24 disposed in a region in which the cables 9 are disposed and the cover portion 8 and the insertion portion 23 may be disposed in the flat portion 24. The cover portion 8 is positioned on an upper surface and a lower surface of the flat portion 24 through the insertion portion 23. That is, at least a portion of the cover portion 8 is fixed to the upper surface and the lower surface of the flat portion 24. Therefore, it is possible to prevent the cover portion 8 from peeling off the base plate 2 while reducing the number of processes to manufacture the base unit 1. Since the insertion portion 23 is provided with the cover portion 8, it is possible to suppress movement of the cover portion 8 in the axial direction and the radial direction.

At this time, the insertion portion 23 may be disposed at a position such that the insertion portion 23 overlaps with at least a portion of the cables 9 in the cover portion 8 in the axial direction as seen in the axial direction. Accordingly, it is possible to dispose the cables 9 in the cover portion 8 and the insertion portion 23 such that the cables 9 and the insertion portion 23 are close to each other and thus it is possible to reduce the amount of resin used for the cover portion 8.

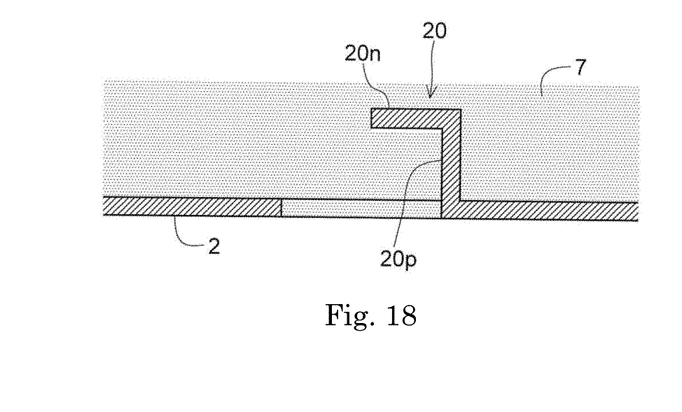

FIG. 18 is a sectional view of the hook portion 20 of the base unit 1 according to a second modification example of the present embodiment, which is cut along the radial direction. The hook portion 20 may be provided with a hook portion protruding portion 20p that protrudes upwards from the base plate 2 and an extending portion 20n that extends in the radial direction from an upper end of the hook portion protruding portion 20p. That is, the hook portion 20 may have an L-like shape as seen in the circumferential direction. Accordingly, it is possible to easily realize the hook portion 20 and it is possible to further prevent the molded portion 7 from peeling off the base plate 2. Note that, any configuration can be adopted as long as the extending portion 20n extends in a direction perpendicular to the axial direction from the upper end of the hook portion protruding portion 20p. Since the hook portion 20 is embedded in the molded portion 7, it is possible to prevent the molded portion 7 from falling off in the axial direction. In addition, since the molded portion 7 covers a surface of the hook portion 20 in the circumferential direction or the radial direction with the hook portion 20 embedded in the molded portion 7, it is possible to suppress movement of the molded portion 7 in the circumferential direction or the radial direction.

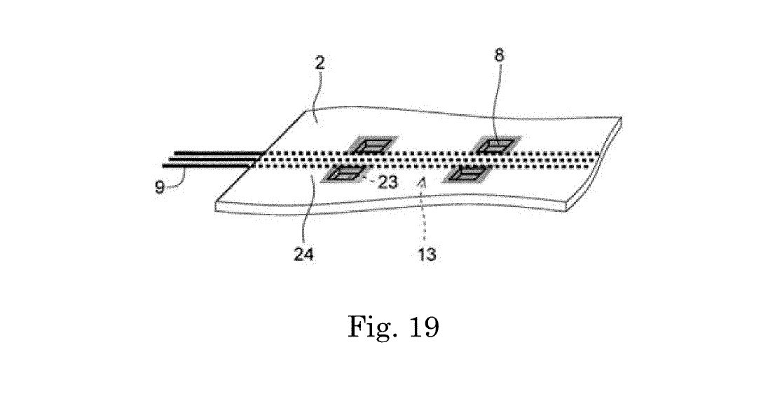

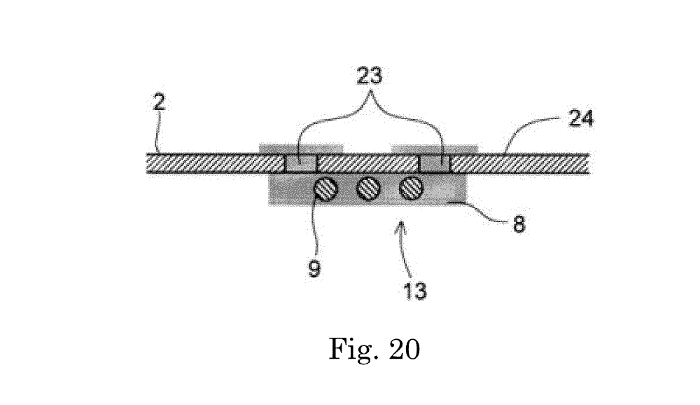

FIG. 19 is a perspective view illustrating the cable installation portion 13 of the base unit 1 according to the second modification example of the present embodiment. FIG. 20 is a sectional view of the base unit 1 according to the second modification example which is cut along the circumferential direction and cut with a plane passing through the insertion portion 23. In the present modification example, the groove portion 22 of the base plate 2 is omitted. A plurality of insertion portions 23 may be provided and, as seen in the axial direction, the plurality of insertion portions 23 that are adjacent to each other in the circumferential direction may be disposed at positions such that the cables 9 in the cover portion 8 are interposed therebetween in the circumferential direction. The cover portion 8 is positioned on the upper surface and the lower surface of the flat portion 24 through the insertion portions 23. That is, at least a portion of the cover portion 8 is fixed to the upper surface and the lower surface of the flat portion 24. Therefore, it is possible to further prevent the cover portion 8 from peeling off the base plate 2. Since the insertion portions 23 are provided with the cover portion 8, it is possible to suppress movement of the cover portion 8 in the axial direction and the radial direction.

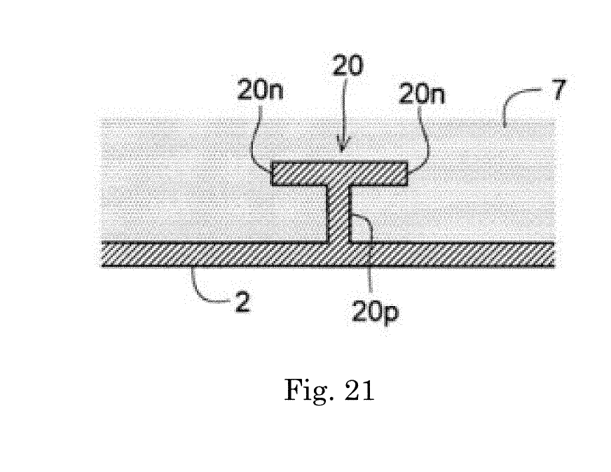

FIG. 21 is a sectional view of the hook portion 20 of the base unit 1 according to a third modification example of the present embodiment, which is cut along the radial direction. The hook portion 20 may be provided with the hook portion protruding portion 20p that protrudes upwards from the base plate 2 and two extending portions 20n that extend in the radial direction from the upper end of the hook portion protruding portion 20p and the two extending portions 20n may extend in opposite directions. That is, the hook portion 20 may have a T-like shape as seen in the circumferential direction. Accordingly, it is possible to easily realize the hook portion 20 and it is possible to further prevent the molded portion 7 from peeling off the base plate 2. Note that, any configuration can be adopted as long as the two extending portions 20n extend in a direction perpendicular to the axial direction. Since the hook portion 20 is embedded in the molded portion 7, it is possible to prevent the molded portion 7 from falling off in the axial direction. In addition, since the molded portion 7 covers a surface of the hook portion 20 in the circumferential direction or the radial direction with the hook portion 20 embedded in the molded portion 7, it is possible to suppress movement of the molded portion 7 in the circumferential direction or the radial direction.

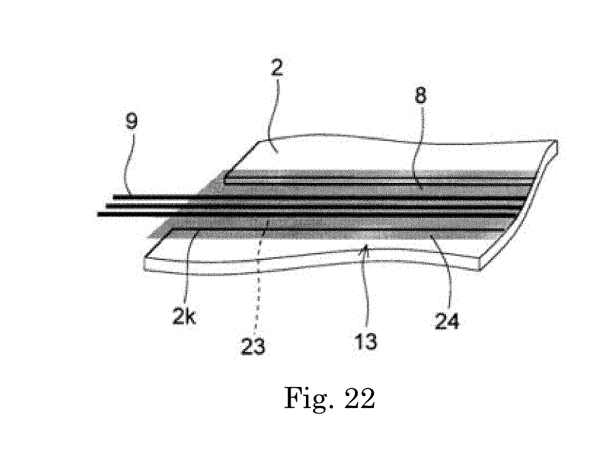

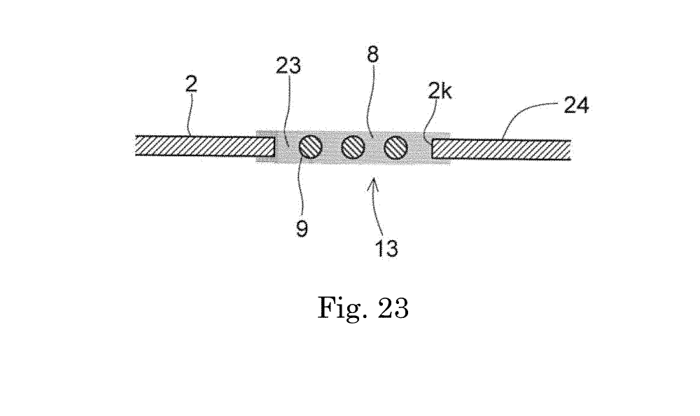

FIG. 22 is a perspective view illustrating the cable installation portion 13 of the base unit 1 according to the third modification example of the present embodiment. FIG. 23 is a sectional view of the base unit 1 according to the third modification example which is cut along the circumferential direction and cut with a plane passing through the insertion portion 23. In the present modification example, the groove portion 22 of the base plate 2 is omitted. The insertion portion 23 may be constituted of a radial notch 2k that is obtained by cutting the base plate 2 in the radial direction from the outer circumferential end. At this time, at least a portion of the cables 9 in the cover portion 8 may be disposed in the radial notch 2k. The cover portion 8 is positioned on the upper surface and the lower surface of the flat portion 24 through the insertion portion 23. That is, at least a portion of the cover portion 8 is fixed to the upper surface and the lower surface of the flat portion 24. Therefore, it is possible to suppress the amount of protrusion of the cover portion 8 from the base plate 2 (the flat portion 24) and it is possible to reduce interference between the cover portion 8 and a component or the like in other equipment which occurs when the base plate 2 is attached to the other equipment such as communication equipment.

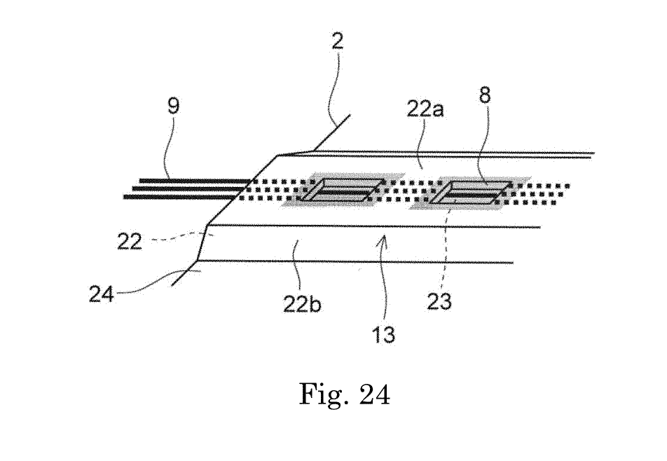

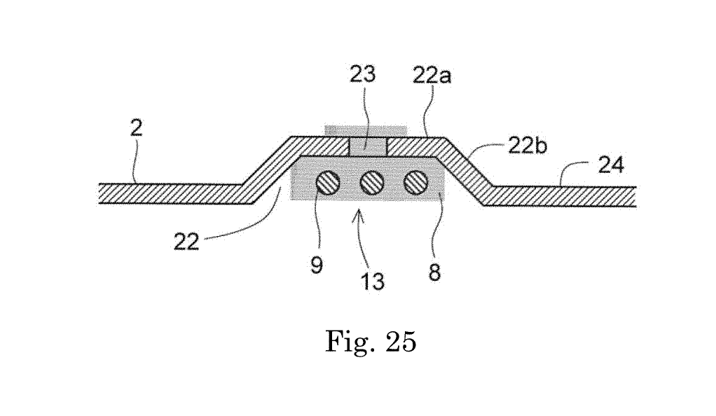

FIG. 24 is a perspective view illustrating the cable installation portion 13 of the base unit 1 according to a fourth modification example of the present embodiment. FIG. 25 is a sectional view of the base unit 1 according to the fourth modification example which is cut along the circumferential direction and cut with a plane passing through the insertion portion 23. The insertion portion 23 which is a through-hole may be disposed only in the bottom wall portion 22a of the groove portion 22. The cover portion 8 is positioned on the upper surface and the lower surface of the bottom wall portion 22a through the insertion portion 23. That is, at least a portion of the cover portion 8 is fixed to the upper surface and the lower surface of the bottom wall portion 22a. Therefore, it is possible to easily fix the cover portion 8 to the groove portion 22. Since the insertion portion 23 is provided with the cover portion 8, it is possible to suppress movement of the cover portion 8 in the axial direction and the radial direction. At this time, the insertion portion 23 may be disposed only in a portion of the bottom wall portion 22a in the circumferential direction (the transverse direction).

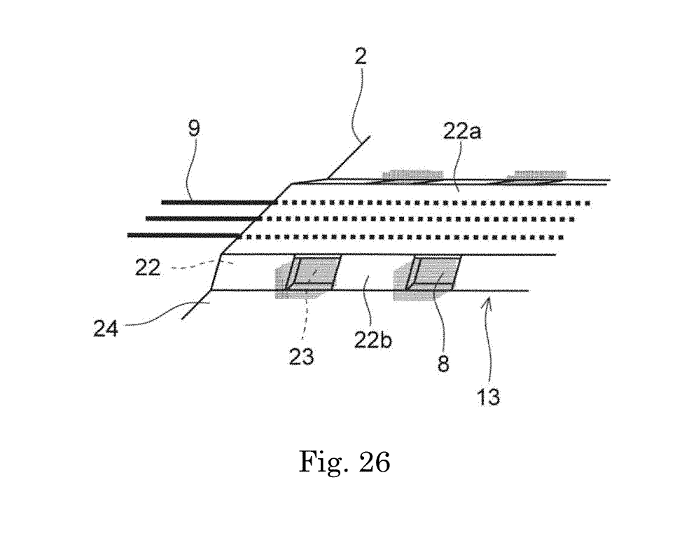

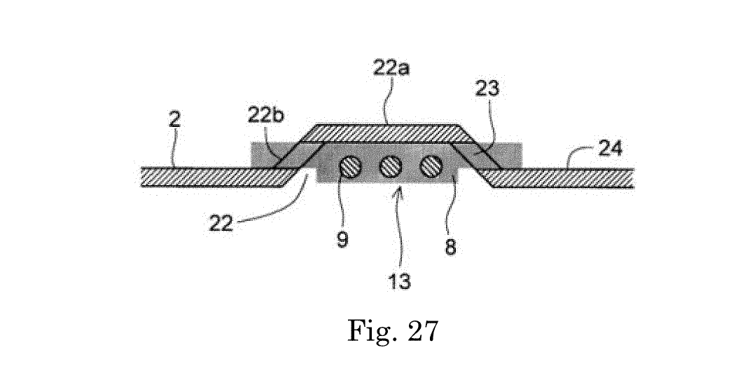

FIG. 26 is a perspective view illustrating the cable installation portion 13 of the base unit 1 according to a fifth modification example of the present embodiment. FIG. 27 is a sectional view of the base unit 1 according to the fifth modification example which is cut along the circumferential direction and cut with a plane passing through the insertion portion 23. The insertion portion 23 may be disposed only in the side wall portion 22b of the groove portion 22 and a portion of the cover portion 8 may be positioned on the upper surface of the flat portion 24 while extending through the insertion portion 23 from the inside of the groove portion 22. At least a portion of the cover portion 8 is positioned on the upper surface of the flat portion 24 and the lower surface of the bottom wall portion 22a via the insertion portion 23. Therefore, it is possible to easily fix the cover portion 8 to the groove portion 22. Since the insertion portion 23 is provided with the cover portion 8, it is possible to suppress movement of the cover portion 8 in the axial direction and the radial direction. Note that, in a case where the upper surface of the base plate 2 is recessed downwards and the groove portion 22 is provided, a portion of the cover portion 8 may be positioned on the lower surface of the flat portion 24 while extending through the insertion portion 23 from the inside of the groove portion 22.

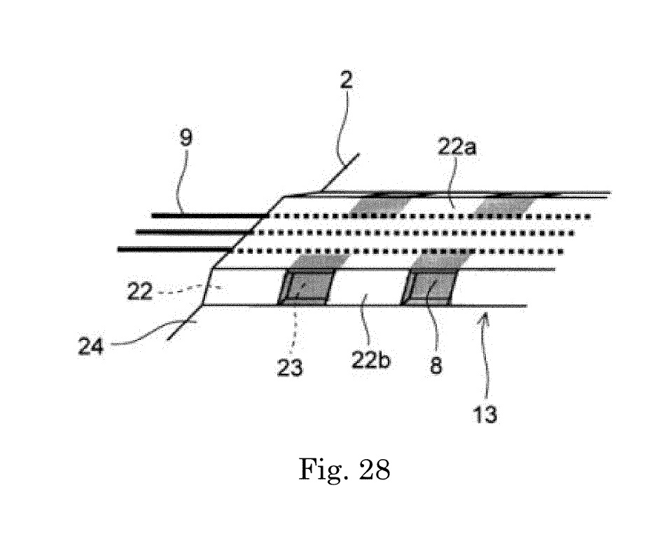

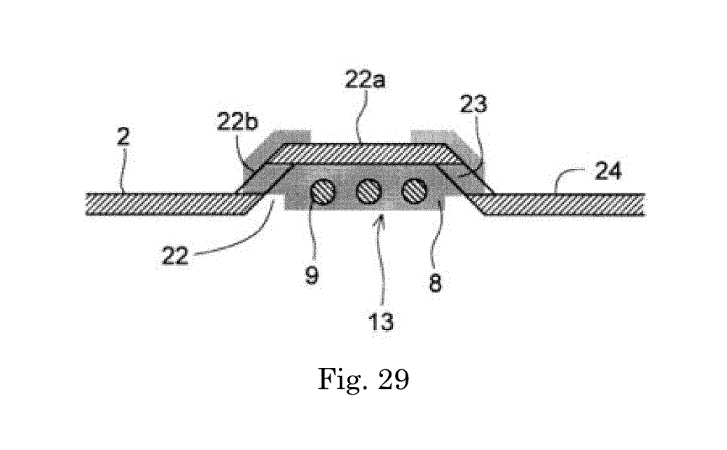

FIG. 28 is a perspective view illustrating the cable installation portion 13 of the base unit 1 according to a sixth modification example of the present embodiment. FIG. 29 is a sectional view of the base unit 1 according to the sixth modification example which is cut along the circumferential direction and cut with a plane passing through the insertion portion 23. The insertion portion 23 may be disposed only in the side wall portion 22b and a portion of the cover portion 8 may extend over the upper and lower surfaces of the bottom wall portion 22a while extending through the insertion portion 23 from the inside of the groove portion 22. Therefore, it is possible to easily fix the cover portion 8 to the groove portion 22. Since the insertion portion 23 is provided with the cover portion 8, it is possible to suppress movement of the cover portion 8 in the axial direction and the radial direction.

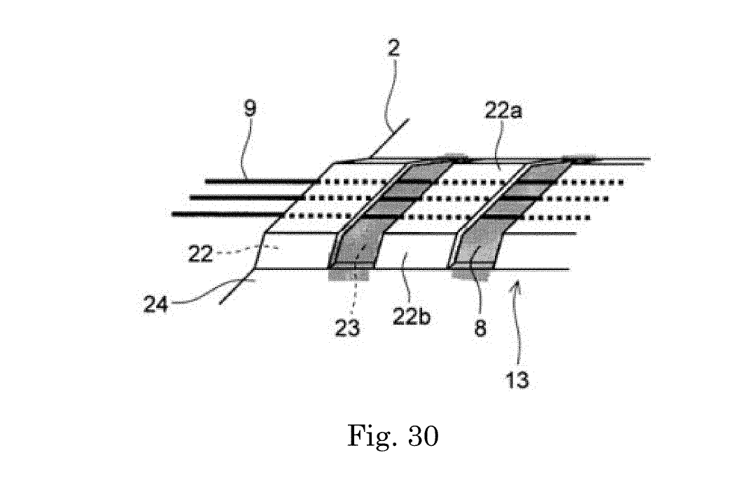

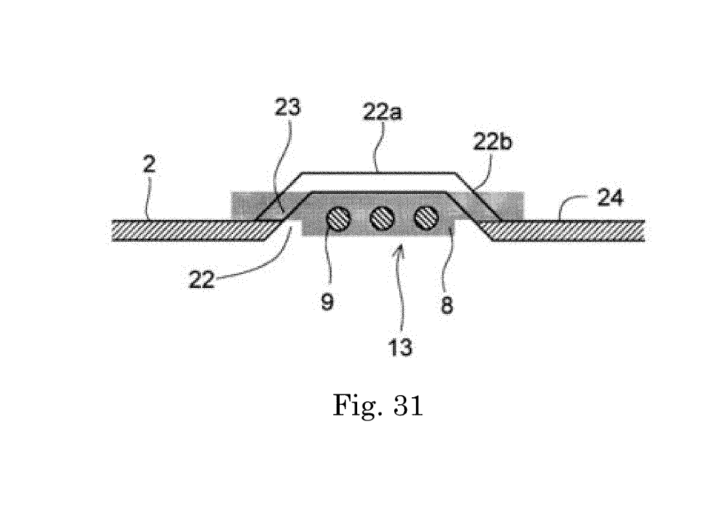

FIG. 30 is a perspective view illustrating the cable installation portion 13 of the base unit 1 according to a seventh modification example of the present embodiment. FIG. 31 is a sectional view of the base unit 1 according to the seventh modification example which is cut along the circumferential direction and cut with a plane passing through the insertion portion 23. The insertion portion 23 may be a through-hole that extends across the bottom wall portion 22a and the side wall portions 22b of the groove portion 22 in the circumferential direction. Therefore, it is possible to easily fix the cover portion 8 to the groove portion 22. Since the insertion portion 23 is provided with the cover portion 8, it is possible to suppress movement of the cover portion 8 in the axial direction and the radial direction.

According to the embodiment, the base unit 1 is provided with the tubular bearing housing 5 that extends in the axial direction while being positioned on the central axis C that extends vertically, the base plate 2 that is connected to the bearing housing 5 and extends in the radial directions, and the stator 3 that is provided on the upper surface of the base plate 2 and is provided radially outward of the bearing housing 5. At least a portion of the base plate 2 and at least a portion of the stator 3 are covered by the molded portion 7 formed of the molding resin MR (resin). The stator 3 and the base plate 2 are connected to each other via the molded portion 7. The base plate 2 is provided with the hook portions 20 that protrude upwards and are caught on the molded portion 7 at least in the axial direction. The hook portions 20 are disposed radially outward of the bearing housing 5.

Therefore, the hook portions 20 can easily resist a force applied to the molded portion 7 in the axial direction and thus it is possible to prevent the molded portion 7 from peeling off the base plate 2. Accordingly, it is possible to firmly fix the stator 3 to the base plate 2 and it is possible to improve the reliability of the base unit 1. In addition, since the stator 3, the base plate 2, and the molded portion 7 are connected to each other, it is possible to increase the hardness of the motor 200 even in the case of the plate-shaped base plate 2 and it is possible to reduce vibration or noise caused by the motor 200.

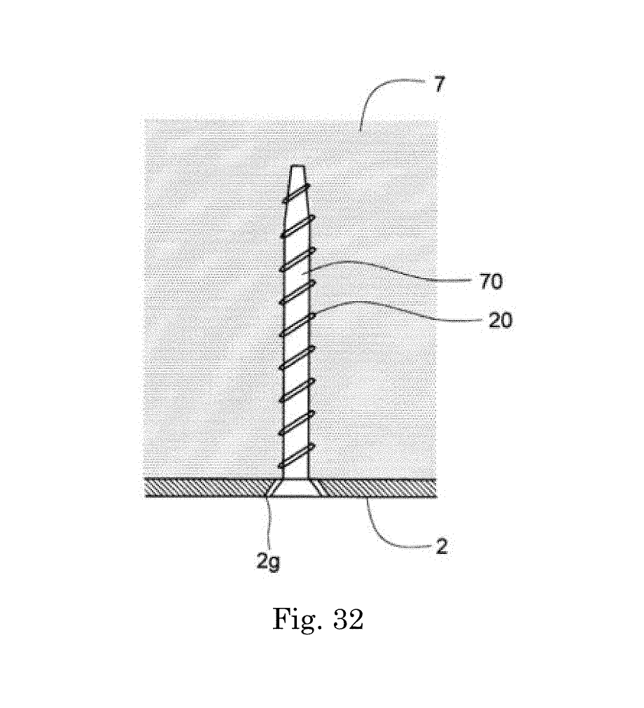

Note that, after the molded portion 7 is formed on the upper surface of the base plate 2, as illustrated in FIG. 32, a screw 70 may be inserted from the lower surface of the base plate 2 via a screw through-hole 2g provided in the base plate 2 such that the screw 70 is screwed into the molded portion 7. In this case, since the screw 70 constitutes the hook portion 20, it is not necessary to form the hook portion 20, which is constituted of the same component as the base plate 2, on the base plate 2. In addition, with the screw 70, it is possible to firmly fix the base plate 2 and the molded portion 7 and it is possible to improve the reliability of the base unit 1.

Each hook portion 20 is provided with the embedded portion 20a embedded in the molded portion 7 and each embedded portion 20a is interposed between portions of the molding resin MR in the vertical direction inside the molded portion 7. Therefore, it is possible to further prevent the molded portion 7 from peeling off the base plate 2.

Each embedded portion 20a may extend in a direction intersecting the circumferential direction. Therefore, the hook portions 20 can easily resist a force applied to the molded portion 7 in the circumferential direction. Accordingly, it is possible to prevent the molded portion 7 from peeling off the base plate 2.

The plurality of hook portions 20 are provided and the plurality of hook portions 20 are disposed to be arranged in the circumferential direction around the central axis C. Therefore, the hook portions 20 can easily resist a force applied to the molded portion 7 in the circumferential direction and it is possible to prevent the molded portion 7 from peeling off the base plate 2.

The hook portions 20 are in a state of being cut and raised from the base plate 2. Therefore, it is possible to easily realize the hook portions 20 and it is possible to suppress an increase in number of components in the base unit 1. In addition, since the hook portions 20 are formed as the same component as the base plate 2, it is possible to firmly fix the base plate 2 and the molded portion 7 in comparison with a case where the hook portions 20 are assembled with the base plate 2 as separate components. That is, it is not necessary to consider the assembling strength between a separate component and the base plate 2.

The hook portions 20 may be inclined with respect to the base plate 2. Therefore, each hook portion 20 is interposed between portions of the molding resin MR in the vertical direction inside the molded portion 7. Accordingly, it is possible to further prevent the molded portion 7 from peeling off the base plate 2 with a simple configuration. Since the hook portion 20 is embedded in the molded portion 7, it is possible to prevent the molded portion 7 from falling off in the axial direction. In addition, since the molded portion 7 covers a surface of the hook portion 20 in the circumferential direction or the radial direction with the hook portion 20 embedded in the molded portion 7, it is possible to suppress movement of the molded portion 7 in the circumferential direction or the radial direction.

The hook portion 20 may be provided with the hook portion protruding portion 20p that protrudes upwards from the base plate and the extending portion 20n that extends in a direction perpendicular to the axial direction from the upper end of the hook portion protruding portion 20p. Accordingly, it is possible to easily realize the hook portion 20 that is firmly caught on the molded portion 7 with a simple configuration and it is possible to further prevent the molded portion 7 from peeling off the base plate 2. Since the hook portion 20 is embedded in the molded portion 7, it is possible to prevent the molded portion 7 from falling off in the axial direction. In addition, since the molded portion 7 covers a surface of the hook portion 20 in the circumferential direction or the radial direction with the hook portion 20 embedded in the molded portion 7, it is possible to suppress movement of the molded portion 7 in the circumferential direction or the radial direction.

The hook portion 20 may be provided with two extending portions 20n and the two extending portions 20n may extend in opposite directions. Accordingly, it is possible to easily realize the hook portion 20 that is firmly caught on the molded portion 7 with a simple configuration and it is possible to further prevent the molded portion 7 from peeling off the base plate 2. Since the hook portion 20 is embedded in the molded portion 7, it is possible to prevent the molded portion 7 from falling off in the axial direction. In addition, since the molded portion 7 covers a surface of the hook portion 20 in the circumferential direction or the radial direction with the hook portion 20 embedded in the molded portion 7, it is possible to suppress movement of the molded portion 7 in the circumferential direction or the radial direction.

Each hook portion 20 is provided with the hook portion through-hole 20b that penetrates the hook portion 20 in the radial direction or the circumferential direction and a portion of the molded portion 7 is disposed in each hook portion through-hole 20b. Therefore, it is possible to easily cause the molding resin MR to flow into the hook portion through-holes 20b of the hook portions 20 and to easily solidify the molding resin MR and it is possible to further prevent the molded portion 7 from peeling off the base plate 2.

The stator 3 is provided with the plurality of coils 33 and the terminal portion 6 that is electrically connected to the lead wires drawn out from the coils 33 is provided between the stator 3 and the base plate 2. The stator 3 and the terminal portion 6 are covered by the molded portion 7. Therefore, it is possible to firmly fix the terminal portion 6 to the base plate 2 via the molded portion 7. In addition, it is possible to achieve the waterproof property of the terminal portion 6.

The outer circumferential end of the molded portion 7 and the hook portions 20 are disposed radially outward of the stator 3. The hook portions 20 are positioned at the outer circumferential end portion of the molded portion 7. Accordingly, since the base plate 2, which is disposed radially outward of the stator 3, is covered by the molded portion 7, it is possible to reinforce the base plate 2 and to improve the hardness of the base plate 2. In addition, since the hook portions 20 are caught on the outer circumferential end portion of the molded portion 7, it is possible to easily suppress the peeling of the molded portion 7 off the base plate 2 which is caused by a stress attributable to distortion or the like of the base plate 2.

The motor 200 is provided with the base unit 1 and the rotor 4 that includes the magnet 42 and rotates around the central axis C, the magnet 42 being disposed radially outward of the stator 3 and the magnet 42 facing the stator 3. The rotor 4 includes the shaft 41 that extends along the central axis C and the shaft 41 is disposed in the bearing housing 5 via the bearing portions 50. Therefore, the stator 3 is firmly fixed to the base plate 2 via the molded portion 7 and thus it is possible to easily realize the motor 200 with which it is possible to reduce vibration and to achieve noise-reduction.

The air blowing device 100 is provided with the motor 200 and the impeller 102 that is provided on the rotor 4 and rotates around the central axis C by being driven by the motor 200. Air from a position above the impeller 102 is sucked when the impeller 102 rotates and the air is discharged downwards. Therefore, the stator 3 is firmly fixed to the base plate 2 via the molded portion 7 and thus it is possible to easily realize the air blowing device 100 with which it is possible to reduce vibration and to achieve noise-reduction. Note that, air from a position above the impeller 102 may be sucked when the impeller 102 rotates and the air may be discharged in the circumferential direction. In addition, air from a position below the impeller 102 may be sucked when the impeller 102 rotates and the air may be discharged upwards or be discharged in the circumferential direction. That is, any configuration can be adopted as long as air from one of a position above the impeller 102 and a position below the impeller 102 is sucked when the impeller 102 rotates and the air is discharged to the other of the position above the impeller 102 and the position below the impeller 102 or the air is discharged in the circumferential direction.

The impeller 102 is provided with the impeller base portion 102a that rotates around the central axis C and the plurality of blades 102b that are provided on the impeller base portion 102a such that the blades 102b are arranged in the circumferential direction. The outer circumferential end of the base plate 2 is positioned radially outward of the impeller base portion 102a. The base plate 2 is provided with the air flowing ports 104 that are disposed radially outward of the impeller base portion 102a and penetrate the base plate 2 in the axial direction. Therefore, it is possible to easily cause an air stream to flow from one of an axially upper side and an axially lower side to the other of the axially upper side and the axially lower side by effectively using the base plate 2 while firmly fixing the base plate 2 to the stator 3.

It is desirable that the width of each air flowing port 104 is 12 mm or less. Therefore, it is not necessary to provide the finger guards 105 separately from the base plate 2 and it is possible to suppress an increase in number of components in the air blowing device 100 with which it is possible to firmly fix the base plate 2 to the stator 3.

The base unit 1 is provided with the tubular bearing housing 5 that extends in the axial direction while being positioned on the central axis C that extends vertically, the base plate 2 that is connected to the bearing housing 5 and extends in the radial directions, the stator 3 that is provided on the upper surface of the base plate 2 and is provided radially outward of the bearing housing 5, and the cables 9 (the conducting member) that are electrically connected to the stator 3 and are drawn out radially outwards from the base plate 2. The conducting member holding portion 21 that holds at least a portion of the cables 9 toward the base plate 2 is provided on at least one of the upper and lower surfaces of the base plate 2. The conducting member holding portion 21 is in a state of being cut and raised from the base plate 2.

Therefore, it is possible to prevent the cables 9 from rising and being separated (lifted) from the base plate 2, from a predetermined position at which the cables 9 are held. Accordingly, it is possible to improve the reliability of the base unit 1. In addition, since the conducting member holding portion 21 is cut and raised from the base plate 2, it is possible to suppress an increase in number of components in the base unit 1. In addition, since the conducting member holding portion 21 is formed as the same component as the base plate 2, it is possible to further prevent the cables 9 from rising and being separated in comparison with a case where the conducting member holding portion 21 is assembled with the base plate 2 as a separate component. That is, it is not necessary to consider the assembling strength between the conducting member holding portion, which is a separate component, and the base plate.

The conducting member holding portion 21 may be provided with the protruding portion 21b that protrudes upwards or downwards from the base plate 2 and the curved portion 21c that is curved from the tip end of the protruding portion 21b in a direction perpendicular to the axial direction and at least a portion of the cables 9 may be accommodated between the curved portion 21c and the base plate 2. Therefore, it is possible to easily restrict movement of the cables 9 in the vertical direction (the axial direction). In addition, since a portion that is open in the circumferential direction is provided between the base plate 2 and the curved portion 21c, it is possible to easily insert the cables 9 into the conducting member holding portion 21 via the portion open in the circumferential direction.

The conducting member holding portion 21 is provided with the holding portion through-hole 21a that penetrates the conducting member holding portion 21 in the radial direction and a portion of the cables 9 is accommodated in the holding portion through-hole 21a. Therefore, it is possible to easily restrict movement of the cables 9 in the vertical direction (the axial direction) and a horizontal direction (the circumferential direction).

At least a portion of the conducting member holding portion 21 and at least a portion of the cables 9 are covered by the molded portion 7 formed of the molding resin MR (resin). The conducting member holding portion 21 and the cables 9 are connected to each other via the molded portion 7. Therefore, the conducting member holding portion 21 and the cables 9 are fixed via the molded portion 7 and it is possible to further restrict movement of the cables 9.

The motor 200 is provided with the base unit 1 and the rotor that includes the magnet 42 and rotates around the central axis C, the magnet 42 being disposed radially outward of the stator 3 and the magnet 42 facing the stator 3. The rotor 4 includes the shaft 41 that extends along the central axis C and the shaft 41 is disposed in the bearing housing 5 via the bearing portions 50. Therefore, it is possible to prevent the cables 9 from being lifted from the base plate 2 and it is possible to easily realize the motor 200 of which the reliability can be improved.

The conducting member holding portion 21 may be disposed at a position on the upper surface of the base plate 2 such that the conducting member holding portion 21 overlaps with a lower end portion of the rotor 4 in the axial direction. Therefore, it is possible to prevent the cables 9 and the rotor 4 from coming into contact with each other.

The air blowing device 100 is provided with the motor 200 and the impeller 102 that is provided on the rotor 4 and rotates around the central axis C by being driven by the motor 200. Air from one of a position above the impeller 102 and a position below the impeller 102 is sucked when the impeller 102 rotates and the air is discharged to the other of the position above the impeller 102 and the position below the impeller 102 or the air is discharged in the circumferential direction. Therefore, it is possible to easily realize the air blowing device 100 with which it is possible to prevent the cables 9 from being lifted from the base plate 2.

The impeller 102 is provided with the impeller base portion 102a that rotates around the central axis C and the plurality of blades 102b that are provided on the impeller base portion 102a such that the blades 102b are arranged in the circumferential direction. The conducting member holding portion faces the impeller 102 in the axial direction at the upper surface of the base plate 2. Therefore, it is possible to prevent the cables 9 and the impeller 102 from coming into contact with each other.

The impeller 102 is provided with the impeller base portion 102a that rotates around the central axis C and the plurality of blades 102b that are provided on the impeller base portion 102a such that the blades 102b are arranged in the circumferential direction. The outer circumferential end of the base plate 2 is positioned radially outward of the impeller base portion 102a. The base plate 2 is provided with the air flowing ports 104 that are disposed radially outward of the impeller base portion 102a and penetrate the base plate 2 in the axial direction. Therefore, it is possible to easily cause an air stream to flow from one of an axially upper side and an axially lower side to the other of the axially upper side and the axially lower side by effectively using the base plate 2 while preventing the cables 9 from being lifted from the base plate 2.

It is desirable that the width of each air flowing port 104 is 12 mm or less. Therefore, it is not necessary to provide the finger guards 105 separately from the base plate 2 and it is possible to suppress an increase in number of components in the air blowing device 100 with which it is possible to prevent the cables 9 from being lifted.

The base unit 1 is provided with the tubular bearing housing 5 that extends in the axial direction while being positioned on the central axis C that extends vertically, the base plate 2 that is connected to the bearing housing 5 and extends in the radial directions, the stator 3 that is provided on the upper surface of the base plate 2 and is provided radially outward of the bearing housing 5, and the cables 9 (the conducting member) that are electrically connected to the stator 3 and are drawn out radially outwards from the base plate 2. The upper surface or the lower surface of the base plate 2 is provided with the resin cover portion 8 that covers at least a portion of the cables 9. The base plate 2 is provided with the insertion portions 23 that are through-holes penetrating the base plate 2 in a direction from the upper surface to the lower surface or notches. In addition, a portion of the cover portion 8 extends over an area from the upper surface of the base plate 2 to the lower surface of the base plate 2 while passing through the insertion portions 23.

Therefore, it is possible to prevent the cover portion 8 from peeling off the base plate 2. In addition, it is possible to prevent the cables 9 from rising on the base plate 2. Accordingly, it is possible to improve the reliability of the base unit 1. In addition, since the cables 9 are covered by the cover portion 8, it is possible to achieve the water-proof property and the dust-proof property of the cables 9. In addition, since the insertion portion 23 is provided with the cover portion 8, it is possible to suppress movement of the cover portion 8 in the axial direction and the radial direction.

The base plate 2 may be provided with the flat portion 24 disposed in a region in which the cables 9 are disposed and the cover portion 8 and the insertion portions 23 may be disposed in the flat portion 24. Therefore, it is possible to prevent the cover portion 8 from peeling off the base plate 2 while reducing the number of processes to manufacture the base plate 2. In addition, since the insertion portion 23 is provided with the cover portion 8, it is possible to suppress movement of the cover portion 8 in the axial direction and the radial direction.

At this time, the insertion portion 23 may be disposed at a position such that the insertion portion 23 overlaps with at least a portion of the cables 9 in the cover portion 8 in the axial direction as seen in the axial direction. Accordingly, it is possible to dispose the cables 9 in the cover portion 8 and the insertion portion 23 such that the cables 9 and the insertion portion 23 are close to each other and thus it is possible to reduce the amount of resin used for the cover portion 8.

A plurality of insertion portions 23 may be provided and, as seen in the axial direction, the plurality of insertion portions 23 that are adjacent to each other in the circumferential direction may be disposed at positions such that the cables 9 in the cover portion 8 are interposed therebetween in the circumferential direction. Therefore, it is possible to further prevent the cover portion 8 from peeling off the base plate 2. In addition, since the insertion portion 23 is provided with the cover portion 8, it is possible to suppress movement of the cover portion 8 in the axial direction and the radial direction.

The insertion portion 23 may be the radial notch 2k that is obtained by cutting the base plate 2 in the radial direction and at least a portion of the cables 9 in the cover portion 8 may be disposed in the radial notch 2k. Therefore, it is possible to suppress the amount of protrusion of the cover portion 8 from the base plate 2 (the flat portion 24) and it is possible to reduce interference between the cover portion 8 and a component or the like in other equipment which occurs when the base plate 2 is attached to the other equipment such as communication equipment.

The base plate 2 is provided with the groove portion 22 that is recessed in the axial direction and extends in the radial direction and the groove portion 22 is provided with the bottom wall portion 22a and the side wall portions 22b that connect the flat portion 24 of the base plate 2 and the bottom wall portion 22a to each other. The cables 9 in the cover portion 8 are accommodated in the groove portion 22. Therefore, it is possible to protect the cables 9 that are drawn out of the stator 3 on the base plate 2.

At this time, the insertion portion 23 may be disposed only in the bottom wall portion 22a. Therefore, it is possible to easily fix the cover portion 8 to the groove portion 22 while protecting the cables 9 with the groove portion 22.

The insertion portion 23 may be disposed only in the side wall portion 22b and a portion of the cover portion 8 may be positioned on the upper surface or the lower surface of the flat portion 24 while extending through the insertion portion 23 from the inside of the groove portion 22. Therefore, it is possible to easily fix the cover portion 8 to the groove portion 22 while protecting the cables 9 with the groove portion 22. In addition, since the insertion portion 23 is provided with the cover portion 8, it is possible to suppress movement of the cover portion 8 in the axial direction and the radial direction.

The insertion portion 23 may be disposed only in the side wall portion 22b and a portion of the cover portion 8 may extend over the upper and lower surfaces of the bottom wall portion 22a while extending through the insertion portion 23 from the inside of the groove portion 22. Therefore, it is possible to easily fix the cover portion 8 to the groove portion 22 while protecting the cables 9 with the groove portion 22. In addition, since the insertion portion 23 is provided with the cover portion 8, it is possible to suppress movement of the cover portion 8 in the axial direction and the radial direction.

The insertion portion 23 may be a through-hole that extends across the bottom wall portion 22a and the side wall portions 22b in the circumferential direction. Therefore, it is possible to easily fix the cover portion 8 to the groove portion 22 while protecting the cables 9 with the groove portion 22.

It is desirable that a circumferential edge portion of the insertion portion 23 is interposed between portions of the cover portion 8 in the vertical direction. Therefore, the cover portion 8 is further firmly fixed to the base plate 2 and thus it is possible to further prevent the cover portion 8 from peeling off the base plate 2. In addition, since the insertion portion 23 is provided with the cover portion 8, it is possible to suppress movement of the cover portion 8 in the axial direction and the radial direction.

The motor 200 is provided with the base unit 1 in which a portion of the cover portion 8 extends over an area from the upper surface of the base plate 2 to the lower surface of the base plate 2 while passing through the insertion portions 23. Therefore, it is possible to prevent the cover portion 8 from peeling off the base plate 2 and it is possible to easily realize the motor 200 of which the reliability can be improved.

The air blowing device 100 is provided with the base unit 1 in which a portion of the cover portion 8 extends over an area from the upper surface of the base plate 2 to the lower surface of the base plate 2 while passing through the insertion portions 23. Therefore, it is possible to prevent the cover portion 8 from peeling off the base plate 2 and it is possible to easily realize the air blowing device 100 of which the reliability can be improved.

The base unit 1 connected to the external power source includes the plurality of cables 9 that are electrically connected to the external power source 90 and extend in the predetermined first direction DR1 and the base plate 2 that is provided with the cable installation portion 13 in which the cables 9 are installed. The plurality of cables 9 are disposed to be arranged in the second direction DR2 perpendicular to the first direction DR1. The cable installation portion 13 is provided with at least one first wall portion 11 that extends in the first direction DR1. Each first wall portion 11 is disposed in at least a portion of a space between the cables 9 that are adjacent to each other. The cables 9 and the first wall portions 11 are fixed to each other via the molding resin. Therefore, it is possible to firmly fix the cables 9 to the cable installation portion 13. In addition, it is possible to prevent the plurality of cables 9 from intersecting each other and it is possible to suppress an increase in thickness of the base unit 1.

Three or more cables 9 are provided and the disposition region R1 in which the first wall portion 11 is disposed is provided in one space between the cables 9 and the non-disposition region R2 in which the first wall portion 11 is not disposed is provided in the other space between the cables 9. The disposition region R1 and the non-disposition region R2 overlap each other in the second direction DR2. Therefore, it is possible to cause the molding resin in a molten state to smoothly flow in the first direction DR1 and it is possible to more easily fix the cables 9 and the first wall portion 11 to each other by using the molding resin.

The plurality of first wall portions 11 are provided and the plurality of first wall portions 11 are disposed at intervals in the first direction DR1. Therefore, since the plurality of first wall portions 11 are provided, it is possible to further prevent the cables 9 from intersecting each other. In addition, when the molding resin in a molten state is caused to flow, the molding resin is likely to flow in the first direction DR1 through the intervals and it is possible to more easily fix the cables 9 and the first wall portions 11 to each other by using the molding resin.

The plurality of first wall portions 11 are provided and two first wall portions 11 that are adjacent to one cable 9 and are provided on the opposite sides with respect to the cable 9 are disposed at different positions in the first direction DR1. Therefore, it is possible to cause the molding resin in a molten state to more smoothly flow in the first direction DR1.

The cable installation portion 13 further includes the second wall portions 12 each of which extends in the second direction DR2 and entirely covers the plurality of cables 9. One end portion of each first wall portion 11 in the first direction DR1 is connected to each second wall portion 12. Accordingly, it is possible to improve the hardness of the cable installation portion 13. In addition, with the second wall portions 12, it is possible to further prevent the plurality of cables 9 from intersecting each other.

The plurality of second wall portions 12 are provided and the plurality of second wall portions 12 are disposed to be arranged in the first direction DR1. The opposite end portions of each first wall portion 11 in the first direction DR1 are connected to each second wall portion 12. Accordingly, it is possible to further improve the hardness of the cable installation portion 13.

Each first wall portion 11 is provided with the recess portion 11a that is recessed in the third direction DR3 that is perpendicular to the first direction DR1 and the second direction DR2. Each recess portion 11a is filled with a portion of the molding resin. Therefore, since it is possible to cause each first wall portion 11 to be interposed between portions of the molding resin in the third direction DR3, it is possible to improve the strength of the first wall portions 11.

Each first wall portion 11 is provided with the recess portion 11a that is recessed toward the cable 9 side in the third direction DR3 that is perpendicular to the first direction DR1 and the second direction DR2. Each recess portion 11a is filled with a portion of molding resin. Therefore, it is possible to cause each first wall portion 11 to be interposed between portions of the molding resin in the third direction DR3 without increasing the thickness of the cable installation portion 13. Accordingly, it is possible to improve the strength of the first wall portions without increasing the thickness of the cable installation portion 13.

The first wall portions 11 are constituted of the same member as the base plate 2. In the present embodiment, the first wall portions 11 and the base plate 2 are formed by subjecting one plate-shaped member to press working. Therefore, it is possible to improve the mass productivity of the base unit 1. Note that, the first wall portions 11 and the base plate 2 may be formed by another method.

The motor 200 is provided with the base plate 2, the plurality of cables, the stator 3, and the rotor that rotates around the central axis C extending vertically and that includes the magnet 42 disposed to face the stator 3 in the radial direction. The cables 9 are electrically connected to the stator 3. Therefore, it is possible to easily realize the motor 200 with which it is possible to firmly fix the cables 9 to the base plate 2.

The base plate 2 supports the stator 3 and the cable installation portion 13 is disposed radially outward of the rotor 4 and the stator 3. In addition, the base plate 2 is provided with the air flowing ports 104 that penetrate the base plate 2 in the axial direction. Therefore, heat of the stator 3 can be discharged to the outside via the air flowing ports 104 such that the motor 200 is cooled.

At this time, it is desirable that the width of the air flowing port 104 is 12 mm or less. Therefore, it is not necessary to provide the finger guards 105 separately from the base plate 2 and it is possible to suppress an increase in number of components in the motor 200.

The air blowing device 100 is provided with the motor 200 and the impeller 102 that is provided on the rotor 4 and rotates around the central axis C by being driven by the motor 200. Air from one of a position above the impeller 102 and a position below the impeller 102 is sucked when the impeller 102 rotates and the air is discharged to the other of the position above the impeller 102 and the position below the impeller 102 or the air is discharged in the circumferential direction. Therefore, it is possible to easily realize the air blowing device 100 with which it is possible to firmly fix the cables 9 to the cable installation portion 13 and to prevent the plurality of cables 9 from intersecting each other.

The present disclosure can be used for a base unit provided with a bearing housing and a stator, a motor provided with the base unit, and an air blowing device provided with the motor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A base unit comprising:
a tubular bearing housing that extends in an axial direction while being positioned on a central axis that extends vertically;
a base plate that is connected to the bearing housing and extends in radial directions; and
a stator that is provided on an upper surface of the base plate and is provided radially outward of the bearing housing,
wherein at least a portion of the base plate and at least a portion of the stator are covered by a molded portion formed of resin,
wherein the stator and the base plate are connected to each other via the molded portion,
wherein the base plate is provided with a hook portion that protrudes upwards and is caught on the molded portion at least in the axial direction, and
wherein the hook portion is disposed radially outward of the bearing housing.

2. The base unit according to claim 1,
wherein the hook portion is provided with an embedded portion embedded in the molded portion, and
wherein the embedded portion is interposed between portions of the resin in a vertical direction inside the molded portion.

3. The base unit according to claim 2,
wherein the embedded portion extends in a direction intersecting a circumferential direction.

4. The base unit according to claim 1,
wherein a plurality of the hook portions are provided, and
wherein the plurality of hook portions are disposed to be arranged in a circumferential direction around the central axis.

5. The base unit according to claim 1,
wherein the hook portion is in a state of being cut and raised from the base plate.

6. The base unit according to claim 1,
wherein the hook portion is inclined with respect to the base plate.

7. The base unit according to claim 1,
wherein the hook portion is provided with a hook portion protruding portion that protrudes upwards from the base plate and an extending portion that extends in a direction perpendicular to the axial direction from an upper end of the hook portion protruding portion.

8. The base unit according to claim 7,
wherein the hook portion is provided with two extending portions and the two extending portions extend in opposite directions.

9. The base unit according to claim 1,
wherein the hook portion is provided with a hook portion through-hole that penetrates the hook portion in the radial direction or a circumferential direction and a portion of the molded portion is disposed in the hook portion through-hole.

10. The base unit according to claim 1,
wherein the stator is provided with a plurality of coils,
wherein a terminal portion that is electrically connected to lead wires drawn out from the coils is provided between the stator and the base plate, and
wherein the stator and the terminal portion are covered by the molded portion.

11. The base unit according to claim 1,
wherein an outer circumferential end of the molded portion and the hook portions are disposed radially outward of the stator and the hook portion is positioned at an outer circumferential end portion of the molded portion.

12. A motor comprising:
the base unit according to claim 1; and
a rotor that includes a magnet and rotates around the central axis, the magnet being disposed radially outward of the stator and the magnet facing the stator,
wherein the rotor includes a shaft that extends along the central axis and the shaft is disposed in the bearing housing via a bearing portion.

13. An air blowing device comprising:
the motor according to claim 12; and
an impeller that is provided on the rotor and rotates around the central axis by being driven by the motor,
wherein air from one of a position above the impeller and a position below the impeller is sucked when the impeller rotates and the air is discharged to the other of the position above the impeller and the position below the impeller or the air is discharged in a circumferential direction.

14. The air blowing device according to claim 13,
wherein the impeller is provided with an impeller base portion that rotates around the central axis and a plurality of blades that are provided on the impeller base portion such that the blades are arranged in the circumferential direction,
wherein an outer circumferential end of the base plate is positioned radially outward of the impeller base portion, and
wherein the base plate is provided with an air flowing port that is disposed radially outward of the impeller base portion and penetrates the base plate in the axial direction.

15. The air blowing device according to claim 14, wherein the width of the air flowing port is 12 mm or less.
